(19) United States
(12) Patent Application Publication
(10) Pub. No.: US 2010/0143558 A1
(43) Pub. Date: Jun. 10, 2010

(54) FRUIT JUICER

(76) Inventors: Yoram Aharonovitch, Haifa (IL); Lea Aharonovitch, Haifa (IL)

Correspondence Address: YORAM TSIVION, P.O. BOX 1307, PARDES HANNA, 37111, IL

(21) Appl. No.: 12/515,431

(22) PCT Filed: Dec. 4, 2007
(86) PCT No.: PCT/IL2007/001491

§ 371 Date: May 19, 2009

(30) Foreign Application Priority Data
Dec. 4, 2006 (IL) 179806

(51) Int. Cl. A23N 1/02; A23N 1/00; A47J 43/04; A23L 2/04

(52) U.S. Cl. 426/489; 99/510; 241/169.1

(57) ABSTRACT

A juicer that produces juice within fruit in particular fruit without large pit(s). The juicer comprises mainly a rod with one or more flexible wires attached thereto. The rod may further comprise an inner straw built-in with holes. The wires may comprise various shaped cutting elements (160, 162) to aid in juicing the fruit's pulp. The rod and wire(s) are configured for removable introduction into the fruit's peel via a naturally occurring opening therein, or at any other location of the peel. The rod and wire(s) are spun within the fruit by a controllable motor or by any other source of rotary motion to juice the pulp, and the peel remains whole and can be used as a cup or a juice container. The rod and wire(s) in particular, can be designed and adjusted to suit virtually almost any fruit, with large variation of acceptable shapes, structures, types, materials, cross-sections, sizes, geometries, locations, and combinations thereof. The juicer can also be used for juicing the contents of appropriate vegetables.

### FIELD OF THE INVENTION

The present invention relates to electrically-operated motor driven fruit juicers that has a controlled motor providing a source of rotary motion that rotate clockwise or counter-clockwise according to the user selection when commanded to operate, a mechanical interface, and a rotary juicing device that comprising , a mixing rod, a limiter, and a multi juicing member assembly which composed from at least one juicing member, that preferably made of flexible nylon cord(s)/line(s)/string(s), or from rust-proof metal wire(s) or from stainless spring(s) steel, that replacing, a conventional blade. The rotary juicing device is coupled to the motor via the mechanical interface, and configured for retrievable introduction into the interior of a suitable fruit.

### BACKGROUND OF THE INVENTION

The fresh squeezed juice of citrus fruit such as orange or red/white grapefruit or red orange or pomelo or red pomelo are consumed frequently as a beverage or constituent of food or as a flavoring in the nutrition of a lot of world-wide populations. Most of the consumers are drinking it only in their houses or in restaurants during light meals, breakfast, lunch, supper, parties and sometimes in outdoors events. They prepare it mainly by using their electrically-operated kitchen motor driven fruit juicers. Users who understand what's good for their body drink it in the preparation stage of the food before the meal, or one hour after the meal. Millions of vegetarians are using healthy natural citrus or other fruits juices frequently in their daily nutrition.

It's a known fact that almost everybody likes to drink fruits juices. To fulfill these huge need and desire of the consumers, a lot of different types of fruit juicers where designed and produced by manufacturers.

Long experience of usage with different types of juicers reveals that, the more the juicers structure is complicated with lots of parts to clean, the messier they are, so customers are exhausted and frustrated, since most of them avoiding and disliking cleaning, washing and drying them, as well as kitchenware or any others simple or complicated instruments. To solve this problem, and to earn fortune from this huge market that have this real, solid and existing need, manufacturers are producing fruits nectars in huge industrial quantities. One of these nectars is Citrus nectar, for example that have the followings ingredients: Filtered water, Orange Concentrate, Orange Cells, Grapefruit Concentrate, Red Orange Concentrate, Citric Acid, Sweetie Concentrate, Vitamin C, Natural Flavorings, Natural Stabilizer Pectin, Folic Acid, Sweetener Sucralose, etc. In the nectars market, it is accepted that the minimum declared fruit content is about 50%. Manufacturers are also producing light fruits drinks in vast industrial quantities, with different fruits, tastes, colors, mixture, dose etc. One of these drinks is grapefruit drink for example, that have the followings ingredients: Filtered water, Grapefruit Juice, Grapefruit components, Natural Stabilizer Pectin, Citric Acid, Sugar, Natural Flavorings, Sweetener Sucralose, Preservatives (E-211, Sulfite), Vitamin C, Folic Acid, Vitamin B-12, etc. To be more attractive to the customers, and to increase their sales and profits, manufacturers are enriching the nectars and the light fruits drinks with vitamins, producing them with or without fruit pulp, with or without sugar supplement as DIET, without preservatives, as low calorie drinks, and selling them in colorful and friendly cardboard boxes, for example. So, it's known that none of the nectars or the light fruits drinks is made only from pure natural juice. The ingredients of these juices are many.

In order to supply the necessity for real natural fresh and squeezed fruit juices to the consumers, different types of Manually operated and Motor driven fruit juicers where invented and manufactured.

Conventional Manually operated fruit juicers are made simply of a plastic juicing element that projecting above a juicer in which juice extracted/squeezed from a fruit is collected in a downwardly pot. To squeeze/extract juice, the user generally cut the fruit for at least two pieces. The chosen cut up part of the fruit is grasped by the user's hand that pressed it down, pushing and crushing it on the juicing element and the wrist joint is repeatedly twisted, again and again and again, thereby rotating randomly the fruit around the juicing element that exists generally in a constant location. The relatively strong forces and the repeated motions required during the juice extraction may result in friction of bones, pain and inflammation of the wrist joint and/or worsening of secondary osteoarthritis or degenerative arthritis or rheumatoid arthritis symptoms. Additionally, this juice extraction process lives juice drops everywhere, so it's a bit messy and some washing and cleaning steps need to be taken.

Traditional Motor driven fruit juicers are considered easy to operator, got better efficiency but often bulkier than manual juicers. Additionally, the added weight of the motor may make them less desirable for use by gentle and elderly customers. Also, motor driven fruit juicers are much more expensive to buy and maintain. The juice extraction process lives a lot of juice remainders, mostly on its inner parts, since most of these instruments are partially sealed, or sealed when they are working. The more their structure is complicated with lots of parts to clean, the messier exhausted and frustrated they are to the lazy customers, who are the majority.

Because of all the disadvantages of the abovementioned juicers, a new solution was needed to improve and to provide the public with. a new and very useful choice. A solution that people will love, solution that will have all the advantages that detailed in the objects of the invention section. Since, that almost everybody likes to drink the real thing—the natural fruits juices, therefore it will be easier to sell a product that most of the people likes or love than to sell something that some of them need.

Since the present invention is to be shared with almost everyone, from almost every social and economic class, in every country, at any time and in any place, therefore a global market is waiting. This device will allow millions to consume fresh, natural and clean fruit juices like they have never use before.

### BRIEF DESCRIPTION OF THE INVENTION

The main part of the present invention consists on a device (FIG. 2, 14A) for making fruit juice in an interior of a suitable fruits, such as citrus fruits mainly.

The fruit juicer comprising mainly from a controlled motor providing a source of rotary motion that rotate clockwise or counter-clockwise according to the user selection when commanded to operate, and from a rotary juicing device coupled to the motor and configured for retrievable introduction into the interior of the suitable fruit. The rotary juicing device being rotated by operation of the motor to produce juice that remains in the interior of the suitable fruit, and the rotary juicing device being retrieved out of the interior of the fruit to allow introduction therein of a straw for retrieving juice out of the fruit.

The rotary juicing device includes a mixing rod supporting at least one juicing member. The notion/combination of the three words—rotary juicing device, will be used in this current fruit juicer patent, by the short definition as—device, or—the device.

The mixing rod and the at least one juicing member are configured for retrievable insertion into the interior of the fruit.

The mixing rod is a rotating rod that preferably made of non-toxic stiff and straight plastic rod (from any selected color), or from a rust-proof metal rod or from a stainless steel rod, or from a wooden rod (like the chopsticks wood or any similar wood). It can also be made of any other material(s) that approved/certified/confirmed by the qualified authorities.

The at least one juicing member is flexible and pliable.

To be more accurate, the Fruit Juicer includes the following at least four main units: (1) The Rotary Juicing Device Unit (RJD); (2) The Control & Drive Unit (CDU); (3) The Mechanical Interface Unit (MIU); (4) And the Filter Straw Unit (S/M FS).

These at least four main units includes the following at least seven sub-units:
(1) The rotary juicing device unit includes at least the Mixing Rod, the Limiter and the Multi Juicing Member sub-units.
(2) The control & drive unit includes at least the Control and the Motor and the I/O components and the Power Supply sub-units.

At least two physically separated main units are quickly connected or taken apart via/by the third unit which is the mechanical interface unit, to enable the juicing process: (1) The rotary juicing device unit. (2) The control & drive unit.

The control & drive unit (CDU) and the mechanical interface unit (MIU) are connected and fixed physically and permanently together as one piece.

The motor axis connected to the mechanical interface with a suitable coupling. This coupling already exists in different versions of motor driven fruit juicers—so, it is not counted as a new part of the Fruit Juicer, but its use by the device is recommended.

The rotary juicing device is an elongated assembly that has at least one juicing member that preferably made of flexible nylon line(s)/cord(s), or from rust-proof metal wire(s) or from stainless spring(s) steel or from any other material(s) that have equal or better qualities that approved/certified/confirmed by the qualified authorities. It's replacing a conventional blade.

The rotary juicing device unit adapted for attachment to the control & drive unit via/by the mechanical interface unit that have also a quick-release blade ability.

The juicing members perform juicing, extracting, mixing, squeezing, cutting, crushing and compress when the mixing rod rotate preferably fast in the interior of the suitable fruit.

To juice/extract/squeeze juice with the device, the user preferably remove the fruit protuberance and reveal the protuberance hole. The user enters slowly the multi juicing member, from the tip into the suitable fruit, through the fruit protuberance hole, almost till the limiter height. Inside the fruit, the juicing members bent or twisted randomly to all the sides during the vertical fast rotation of the mixing rod that connected to the motor that is fixed in the control & drive unit, so they generate fruit juice. Any other penetration points on the fruit casing are possible but are not preferred or recommended.

The juicing members are fixed at different elevations with respect to each other. There are at least several layers of juicing members; their quantity/number depend on the size and the structure of the fruit. In every layer, there is at least one or several juicing member(s). Basically, there is one juicing member from each side of the mixing rod in the same elevation. Practically, these two juicing members in the same elevation can be counted as one with two ends if they are made from one piece that passes through a hole that was made (drilled, for example) especially for this purpose in the mixing rod.

Each juicing member (“branch”) in every layer can be built/made equally or differently from the other juicing members in the multi juicing member sub-unit (“tree”) according to each specific design. Every juicing member got its own unique characteristics: (1) Thickness Shape (circular, square, rectangular, triangle etc); (2) Length Shape; (3) Thickness of the homogeneous circle juicing member (1.3 mm, 1.6 mm, or 2.0 mm, etc); (4) Direction for winding; (5) Active Length; (6) Type(s) of material(s); (7) Weight; (8) Elasticity level; (9) Roughness level; (10) Material density level; (11) Structure (twined from several fibers or wires or from one homogeneous fiber or wire); (12) For heavy or light duty; (13) Color; (14) End piece types; (15) Outer Edge Form (ball shaped, straight cut, etc); (16) Edge unit; (17) Angle; (18) Location; (19) Short or Long flexible line/cord; (20) Capture method; (21) Connection type; (22) Depth of the drilling, etc.

The abovementioned characteristics, plus: (1) the Type of the rotary juicing device (thin, thick, coarse, etc); (2) the Shape of rotary juicing device (triangle, spherical, ellipse, etc); (3) the number of the active layers; (4) the rotation mode (CW, Variable, Programmed); (5) the rotation speed of the mixing rod; (6) the angle of the penetration into the fruit; (7) the depth of the penetration into the fruit; (8) the homogeneous motion in all the inner relevant content of the fruit; (9) the time work duration inside the fruit; (10) and some other motion control parameters. All these together determine the size and the quality of the juicing (the process to extract the juice of)/squeezing inside the fruits.

The limiter sub-unit is a variable mechanism biased on a screw—thread (only for example), which set manually by the user, for avoiding any damage to the fruit peels, so it eliminates any juice leakage(s). Any better solution can be counted.

The mechanical interface unit (MIU) coupled the rotary juicing device to the controlled motor.

When the juice is ready inside the suitable fruit, the rotary juicing device being retrieved out of the interior of the fruit to allow introduction therein of a straw (a single or a multi preferable filter straw) for retrieving juice out of the fruit.

A suitable fruit—is a fruit that: (1) Its shell has to be thick, hard and strong enough. (2) Juicy inside. (3) With little amount of seeds, that won't cause any cracking of the shell during the squeeze, extract etc. its preferable, (4) Homogenous inside. (5) Has to be for all kinds of fruits exist in the world. (6) The values of all these parameters must be measured carefully.

### OBJECTS OF THE INVENTION

The objects of the present invention are:

(One) To provide the best solution for making/getting maximum squeezed, natural and fresh fruit juice in an interior of a suitable fruit, under the sealed fruit peel that apricots as a cup, since the fruit peel left almost one complete piece after the penetration and the juicing/squeezing/mixing processes. Because of this great advantage there is no need to remove the juice from the fruit to an external cup.

(Two) To provide a mini portable and controlled fruit juicer (FIGS. 1 & 2) for juicing, extracting, mixing, squeezing, cutting, and crushing the most of the inner contents of regular or organic citrus fruits or other fruits, until they become juice with pulp for drinking, in the interior of the suitable fruits, instantly, in everywhere (indoors, outdoors etc) at anytime (24 hours, 7 days a week, every year).

(Three) To provide a personal motor driven Fruit Juicer.

(Four) To provide a compact, simple to transport and lightweight indispensable indoors, kitchens and outdoors tool for personal usage with different designing shapes, colors, sizes and names. This tool is almost for all: kids, teenagers, young adults, parents, grandparents, and the elderly.

(Five) To provide a fruit juicer for people on-the-go, like workers everywhere, athletes in training, trippers, pupils, students, soldiers, people recovering from sickness, injury or surgery, etc. People will conveniently carry it to vacations, to work, to school, to football pitch, tennis court, to play, to watch games from all the kinds, to exercise, on a walk, on a bike ride, on a run, on the bus, in a car, in a train, in a plane etc.

(Six) To provide a low cost fruit juicer.

(Seven) To provide a fruit juicer that is convenient to carry, friendly, simply, easy to use and fun for usage, share and maintain. For example, it's easy for beginners because its operation is simple, and the consumers can start using it a few minutes after purchasing.

(Eight) To provide only the inner-fruit content, without any additional and external additives such as preservatives or any other synthetic or natural ingredients. The option to get also inner fruit peel particles inside the blend/puree required the usage of multi juicing member (FIGS. 2, 1A & 2A) with outer edges (FIG. 2, 21A) that have straight or any sharp cuts (blade, thorny, split head, etc) (FIG. 3A, A-E).

(Nine) To provide the best solution for getting clean, squeezed and natural fruit juice without chemicals or toxic materials like extermination materials or acidic rain that are mostly saturated inside almost every existing regular fruits peel. It's known that these poisons are pressed and leak from the fruit peel into the clean juice, during every manual or automatic crushing or squeezing process of almost any partial or entire fruit which includes some or all of its peel at the same process time, in home kitchen's where people are using their manual juice squeezers or their electrically-operated juicers, or in the industrial production lines that are using big industrial juicers.

(Ten) To provide a fruit juicer with minimum parts to clean—less to maintain. In this said invention, there is only one assembly to clean—the rotary juicing device (FIGS. 2, 14A & 2A), and only from the outside since its cast and sealed.

(Eleven) To provide an exciting and brilliant juicing/squeezing solution that will definitely impress the customers.

(Twelve) To provide a variable motor speed rotation (FIG. 13A, 7, 8A, 11) for getting a better control and better efficiency on the juicing/squeezing/mixing processes.

(Thirteen) To provide a one-time or permanent device (FIG. 2, 14A) that enables quick and easy penetration ability into the interior of desired fruits through the fruit protuberance hole, or through their peels. The fruits protuberance hole is the best and the preferable penetration point.

(Fourteen) To provide a fruit juicer that don't need any significant human physical forces for executing the penetrating, the juicing or the squeezing or the mixing processes.

(Fifteen) To provide the juicer structure of this novel Fruit Juicer that is electrically rotating operated, that works with multi juicing member sub-unit (FIG. 2, 1A) or with at least one rotary juicing member (FIGS. 7, 1 & 8, 1 & 9, 1) that preferably made from flexible nylon line/string (FIGS. 2, 1A & 7, 1 & 11, 1 & 12, 1B). As noted the rotary juicing device is not using a conventional metal blade(s) so there are no corrosion problems.

(Sixteen) To provide the best solution for obtaining minimum juice remainders outside the fruit, during the juicing/extracting/squeezing processes and the usage.

(Seventeen) To provide a convenient and affordable state-of-the-art technologies that will dramatically transform the personal usage/habits of juicing/squeezing natural, fresh and clean fruit juices.

(Eighteen) To provide a fruit juicer that is fast in juicing for suitable fruits like citrus fruits such as orange, red/white grapefruit, red orange, pomelo, red pomelo, mandarin, Clementine, lemon etc, or other fruits like melon, watermelon, pineapple, Chinese persimmon etc, until they become juice with or without pulp for drinking.

(Nineteen) To provide an effective way to ingest liquid natural fruits beverages with a lot of fresh vitamins especially like vitamin C, instead of getting “them” by pills, mixing powders, gel, fruits nectars or light fruits drinks. People that have mainly physical problems are swallowing tablets. Tablets are not liquids; their powdered ingredients are pressed in 10,000-20,000 psi (pounds). Using high pressures and increased temperatures, allow the chemical binders to cement the tablets into solid form. Tablets take time to break apart, dissolve and then release their active ingredients. Powders are bulky, are not convenient, require a measuring cup, and require liquids and a mixing container. They are messy.

(Twenty) To provide a family of products and their sub-assemblies (FIGS. 2 & 2A & 2B & 3 & 3A & 3B & 4 & 5 & 6 & 7 & 9 & 10 & 11 & 12 & 14 & 15 & 15A & 16 & 16A). The main products (FIGS. 2 & 3 & 4 & 7 & 11 & 12) are called as Fruit Juicers (or Juicers).

(Twenty-one) To provide a new single filter straw (FIG. 14, 30) that is preferably made from long straight stiff and thin plastic pipe. When the juice is ready inside the fruit, the rotary juicing device (FIG. 2, 14A) being retrieved out of the interior of the fruit to allow introduction therein of the single filter straw for retrieving the juice out of the fruit, filtered or not from the pulp.

(Twenty-two) To provide a new multi filter straw (FIG. 15, 31) that preferably has one main straw (FIG. 15, 23) that made from preferable stiff and thin plastic (or any other desired material) that connected to a Y-junction (FIGS. 15, 24 & 15A, 24) that split to at least two filter straws (FIG. 15, 25, 26).

(Twenty-three) To provide the best solution for storing unfinished, available, squeezed and natural fruit juices inside the fruits, in indoors appliances such as refrigerators, or in outdoors. For this purpose a cork (FIG. 16, 27) plus a cork and straw interface (FIG. 16, 67) are in use to seal the hole in the suitable fruit peel, plus suitable base (FIG. 16, 28) to lay down the fruit on, to prevent any leaks from the treated fruit.

(Twenty-four) To provide a vast model selection (FIGS. 1 & 3 & 7 & 11 & 12 & 14 & 15 & 16 etc) of novel and different designing shapes, colors and names for the benefit of kids, youth, adult and old people.

(Twenty-five) To provide a fruit juicer that is powered by external source of electricity (FIG. 2, 16A) via transformer indoors or using cares battery power via the cigarette-lighter plug in outdoors.

(Twenty-six) To provide the best solution, that will become the most popular personal motor driven Fruit Juicer.

### BRIEF DESCRIPTION OF THE FIGURES

The above as well as other goals of the present invention will become apparent when reading the accompanying description and drawings in which:

FIG. 1 Shows the side-view of the motor driven Fruit Juicer according to the present invention (the source version).

FIG. 2 Shows the detailed side-view of the motor driven Fruit Juicer, according to the present invention (the source version), that pinpointing on the main units—the rotary juicing device (14A), the mechanical interface unit (4A), and the control & drive unit (20A).

FIG. 2A Shows the partial perspective view of the multi juicing member sub-unit (1A) that is a part of the rotary juicing device unit, according to the present invention (the source version).

FIG. 2B Shows the partial, side/front view of a multi juicing member sub-unit, that has on it a big collection of many types of juicing members (for example), according to the present invention (the source version).

FIG. 3 Shows detailed side-view of another motor driven Fruit Juicer with the rechargeable battery option, according to the present invention (optional version #1). It displays also some of the inner blocks options (4A, 7, 8A, 9A, 10).

FIG. 3A Shows an upper cross-section view of the mixing rod (2A) and juicing member(s), with some of their different connections options (A, B, C, D, E) (only for example).

FIG. 3B Shows an upper cross-section view of the mixing rod (2A) and juicing member(s), with some of their different shapes (51, 52, 53, 54, 56) and some connections options (only for example). Their shape can be designed in any/every creative free line, according to engineering considerations.

FIG. 4 Shows another side-view of the motor driven Fruit Juicer with the rechargeable battery option, with respect to the connection for external power source (16C), according to the present invention (optional version #1).

FIG. 5 Shows another side-view of the motor driven Fruit Juicer according to the present invention (the source version), with a detailed drawing of the limiter sub-unit (6A, 6AA).

FIG. 6 Shows another side-view of the motor driven Fruit Juicer according to the present invention (the source version), with a detailed drawing of an optional limiter sub-unit (6B, 6AB) (for example).

FIG. 7 Shows a side-view of motor driven Fruit Juicer, according to the present invention (optional version #2), that has at least two different units from the source version—the rotary juicing device (14) and the mechanical interface unit (4).

FIG. 8 Shows a detailed side-view of motor driven Fruit Juicer, according to the present invention (optional version #2), with detailed drawing of some inner blocks and I/O components.

FIG. 9 Shows the partial lower side-view of rotary juicing device (FIG. 7, 14) in an interior of a suitable fruit, according to the present invention (optional version #2), with detailed drawing of one juicing member (1).

FIG. 10 Shows a drawing of two upper partial side-view & cross-section options of rotary juicing device (FIG. 7, 14), according to the present invention (optional version #2). Option #1 (32), is for constant usage, and option #2 (33) is for one-time usage.

FIG. 11 Shows a perspective view of motor driven Fruit Juicer according to the present invention (optional version #3).

FIG. 12 Shows a side-view of motor driven Fruit Juicer according to the present invention (optional version # 4).

FIG. 13 Shows the simplified block diagram of the motor driven Fruit Juicer according to the present invention.

FIG. 13A Shows most of the blocks and their preferable location in the device according to the present invention (the source version).

FIG. 14 Shows the front/side view of the single filter straw for complementary usage with the present invention (for all the versions).

FIG. 15 Shows the front view of the multi filter straw for complementary usage with the present invention (for all the versions).

FIG. 15A Shows the front & cross-section view of the Y-JUNCTION in the multi filter straw sub-unit (24) in the present invention (for all the versions). This design is displayed only for example, it can be in any other shape, design and other parameters).

FIG. 16 Shows the side/front & cross-section view of an interior of a suitable unfinished fruit with a cork (27), plus a cork & straw interface (67), plus a suitable base for the fruit (28), for complementary usage with the present invention (for all the versions). An unfinished fruit is a fruit that still contains some liquid juice in its interior part.

FIG. 16A Shows the perspective view of a cork & straw interface (CSI) that stuck in the protuberance hole of a suitable fruit, for complementary usage with the present invention (for all the versions).

FIGS. 17, 17A Shows the fruit juicer process flow chart of the present invention (the source version).

FIG. 18 Shows the perspective view of a vertical rotary juicing device unit, one of the optional future products (for example), according to the present invention (the source version).

FIG. 19 Shows the side-view of a new working vertical rotary juicing device, according to the present invention (the source version).

FIG. 20 Shows the side-view of a new vertical rotary juicing device unit, one of the future optional products (for example), according to the present invention (the source version).

FIG. 21 Shows a side-view of the start position, first in a series, of how the juicer penetrate with a new vertical rotary juicing device to a fruit.

FIG. 22 Shows a side-view of the second position, of how the juicer penetrate with a new vertical rotary juicing device to a fruit.

FIG. 23 Shows a side-view of the third position, of how the juicer penetrate with a new vertical rotary juicing device to a fruit.

FIG. 24 Shows a side-view of the fourth position, of how the juicer penetrate with a new vertical rotary juicing device to a fruit.

FIG. 25 Shows a side-view of a wide collection of cords, lines strings, wires, for getting better blade abilities with simple wire.

FIG. 26 Shows a side-view of another wide collection of cords, lines strings, wires, for getting better blade abilities with simple wire.

FIG. 27 Shows a side-view of another wide collection of edges of cords, lines strings, wires, for getting better blade abilities with simple wires.

### DETAILED DESCRIPTION OF THE INVENTION

### The Fruit Juicer

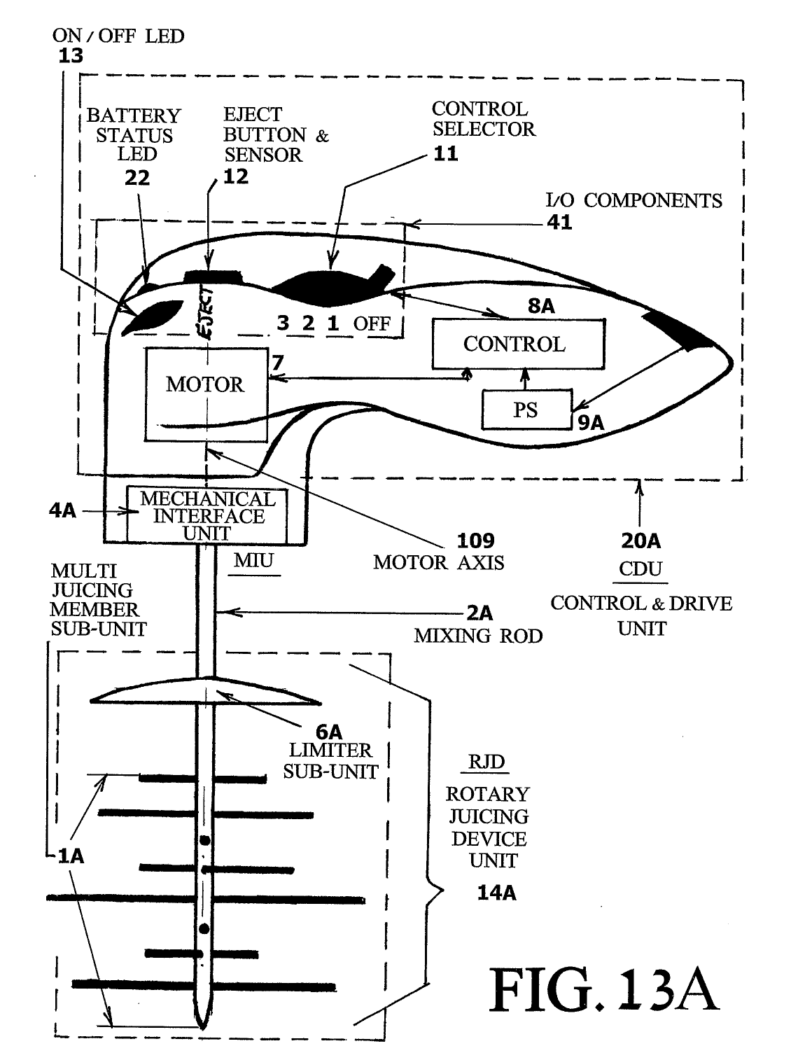

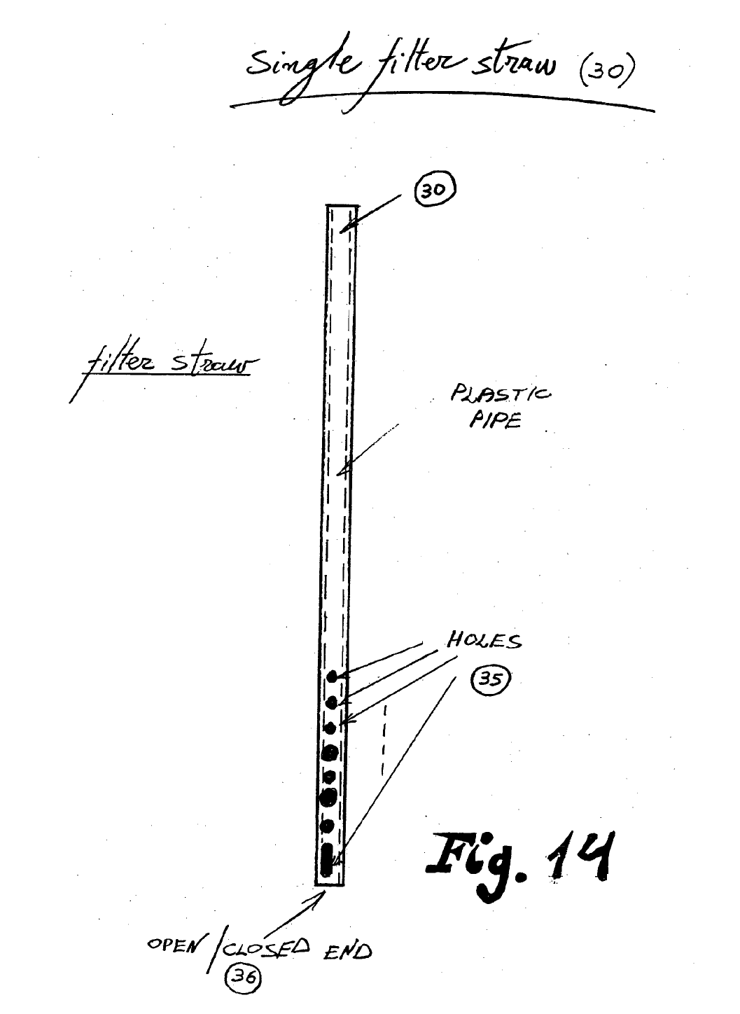

FIG. 13 shows the simplified block diagram of the motor driven Fruit Juicer according to the present invention.

FIG. 13A shows most of the blocks and their preferable location in the fruit juicer according to the present invention.

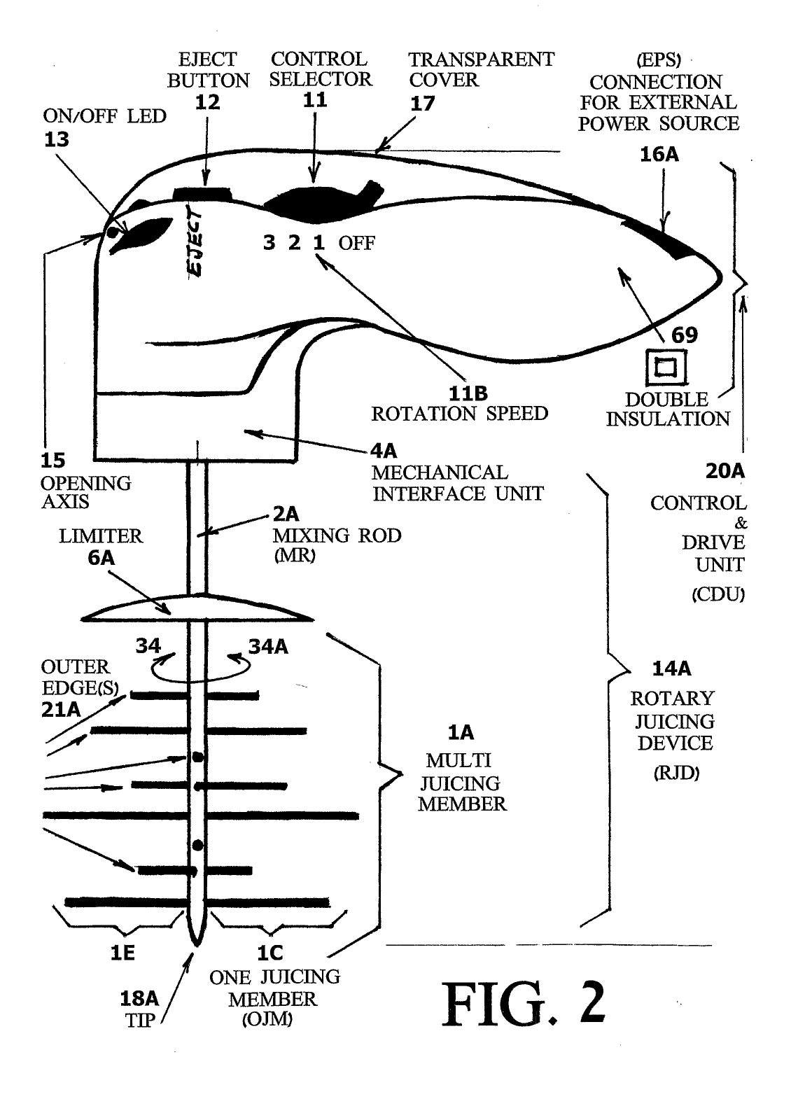

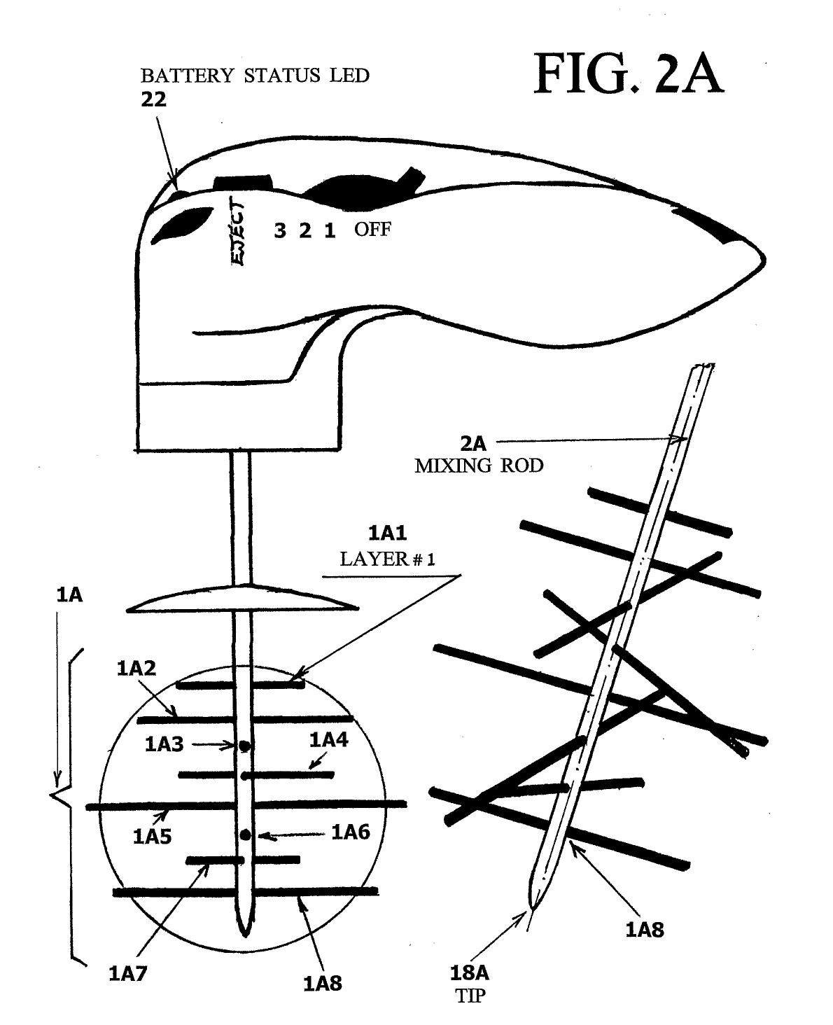

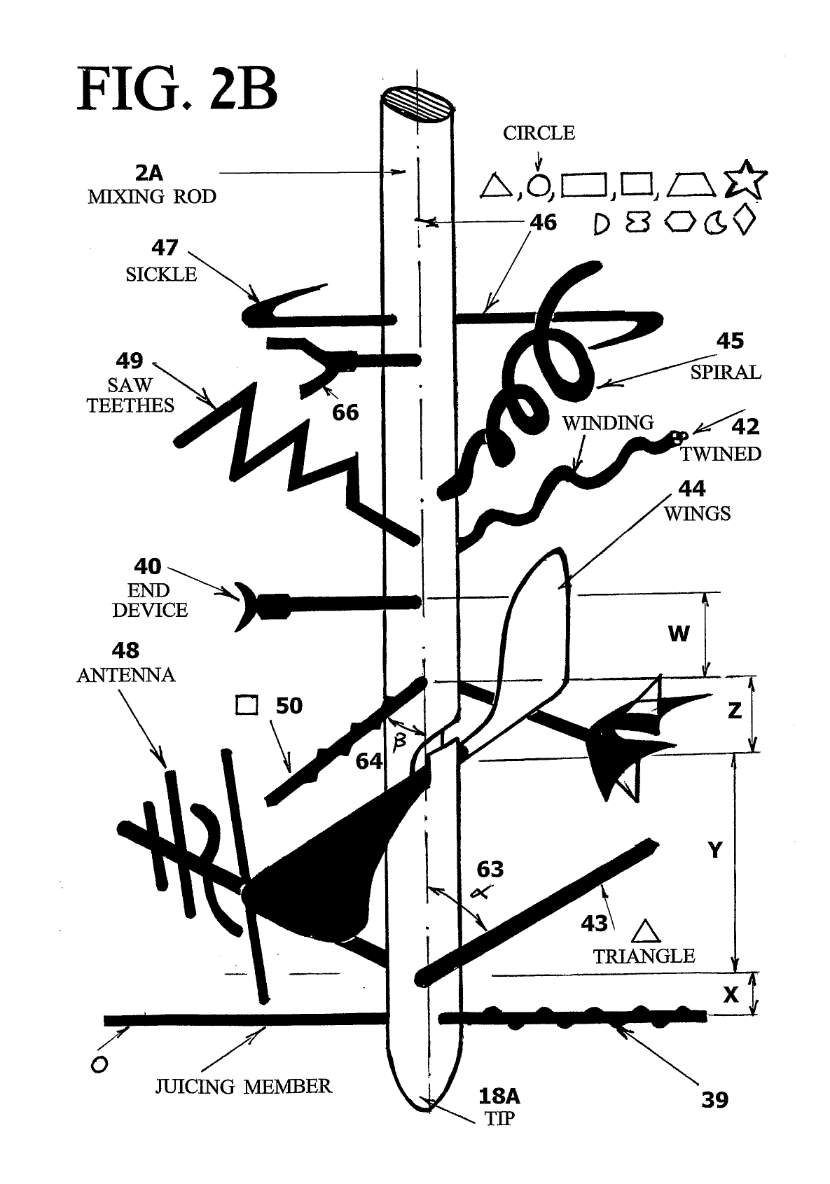

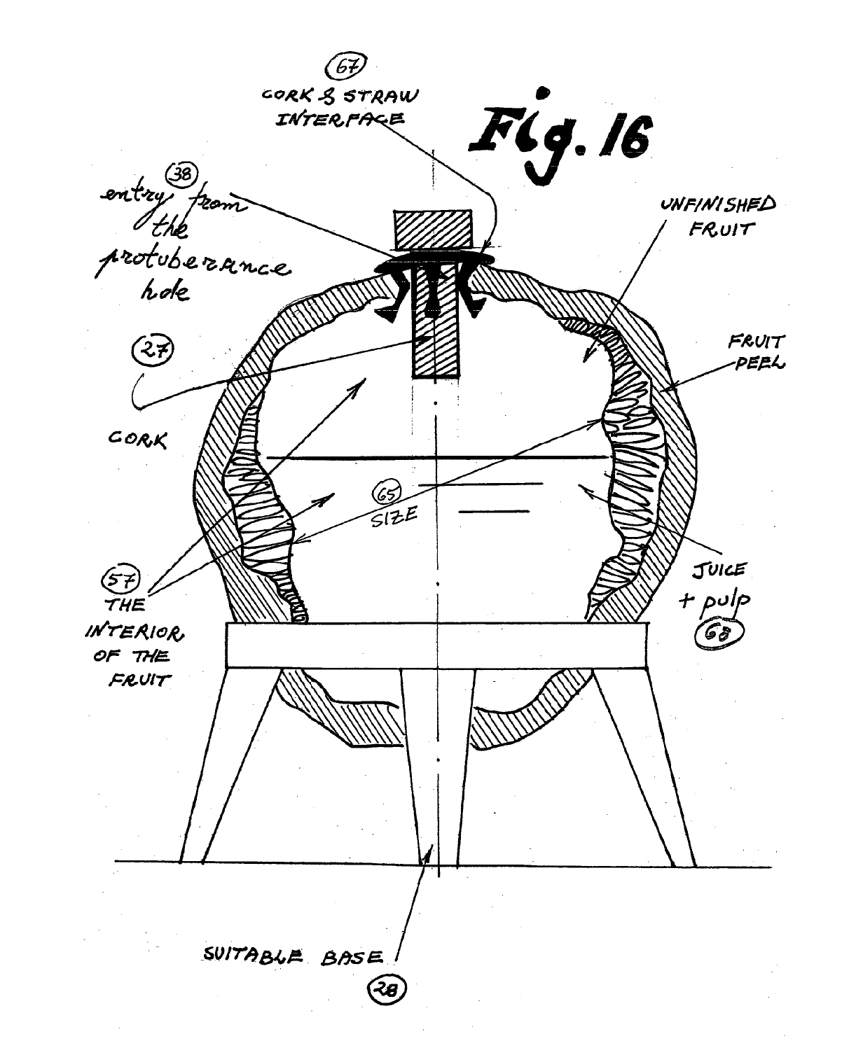

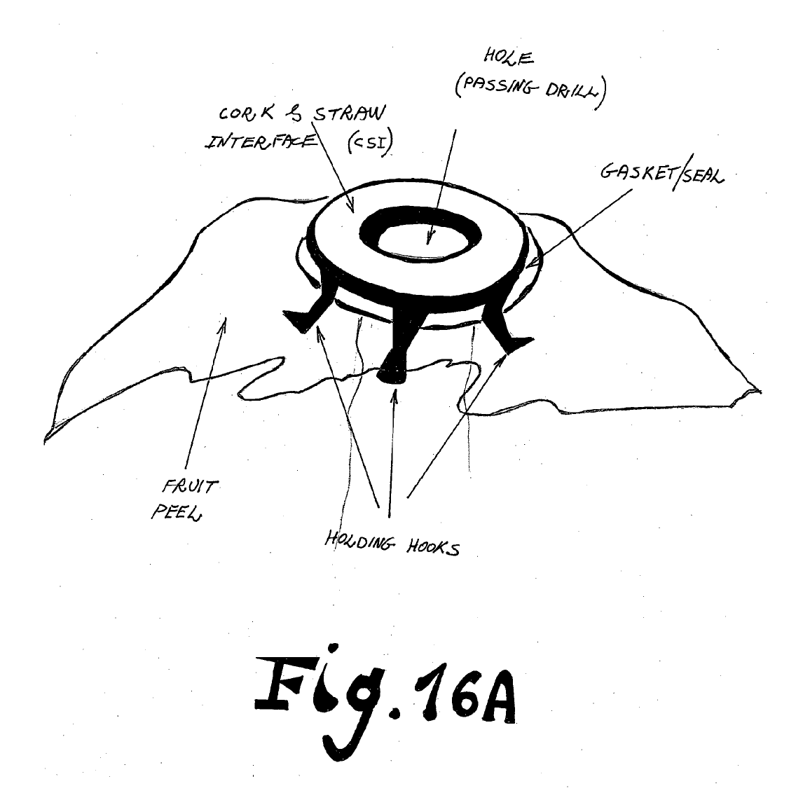

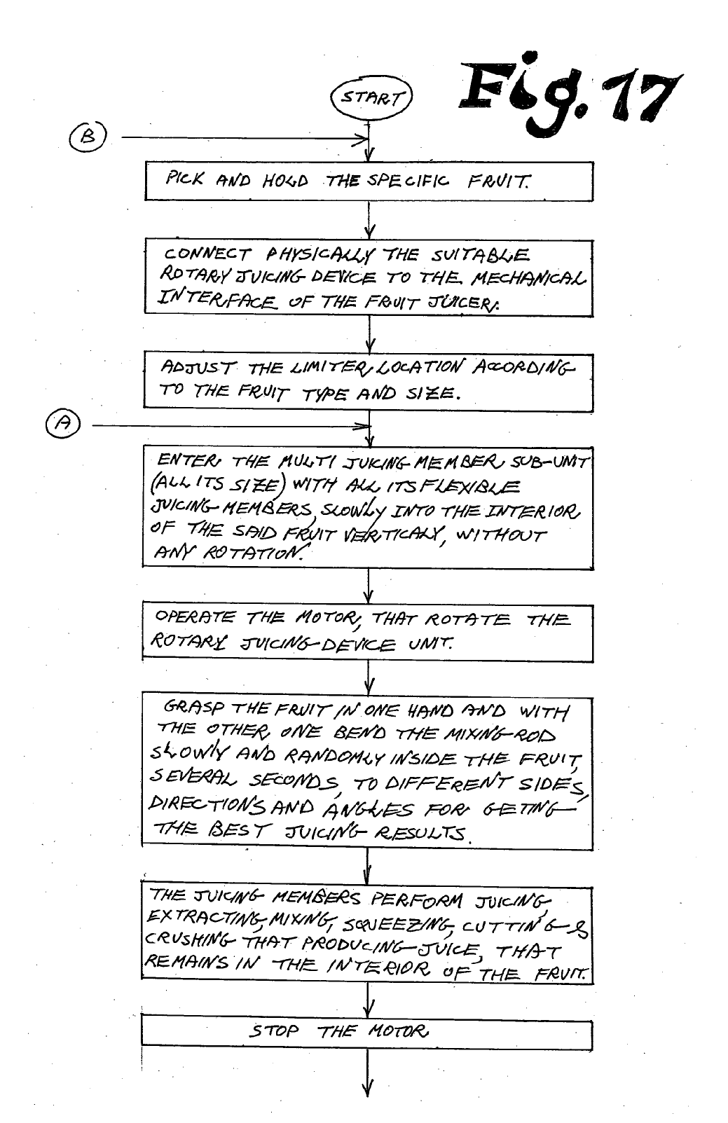

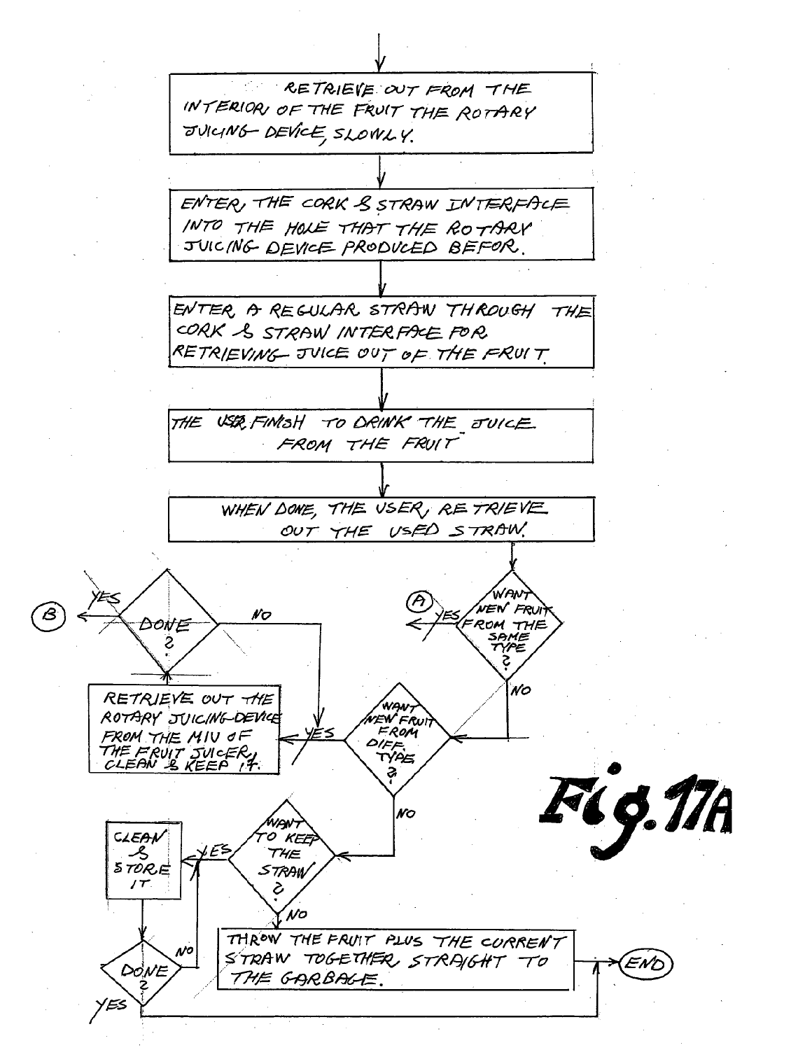

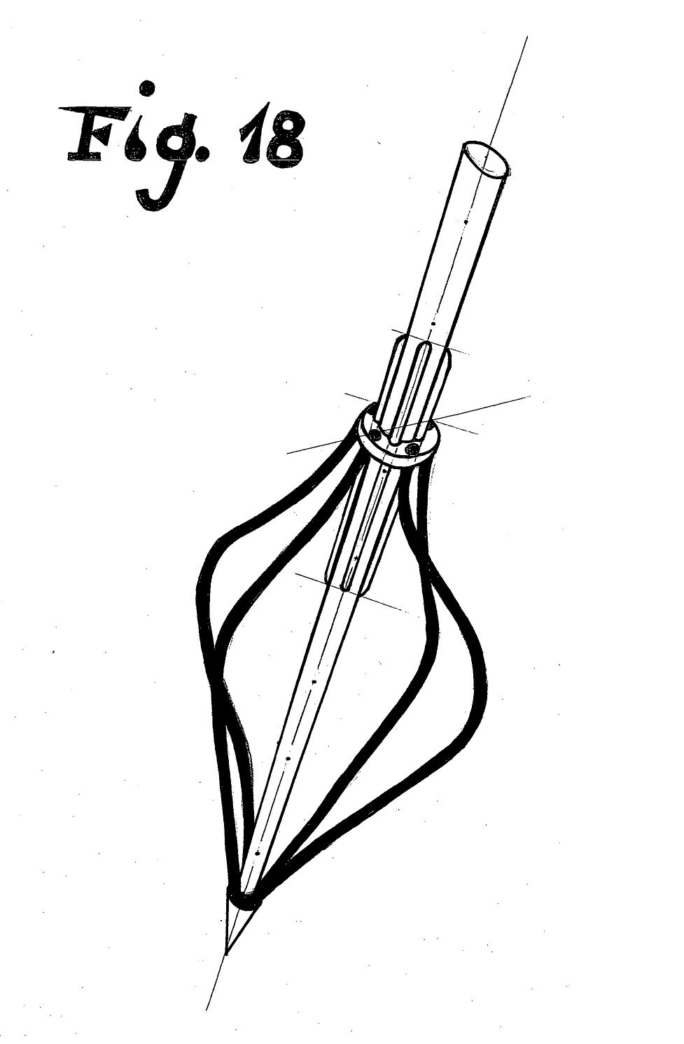

The main part of the present invention consists on a device (FIG. 2, 14A) for making fruit juice in an interior of suitable fruits (FIGS. 16, 57 & 16, 68), such as citrus fruits mainly.

The fruit juicer comprising mainly from a controlled motor (FIG. 13A, 7) providing a source of rotary motion that rotate clockwise or counter-clockwise according to the user selection when commanded to operate, and from a rotary juicing device (FIG. 13A, 14A) coupled to the motor and configured for retrievable introduction into the interior of the suitable fruit. The rotary juicing device being rotated by operation of the motor to produce juice that remains in the interior of the suitable fruit, and the rotary juicing device being retrieved out of the interior of the fruit to allow introduction therein of a straw (FIGS. 14 & 15) for retrieving juice out of the fruit.

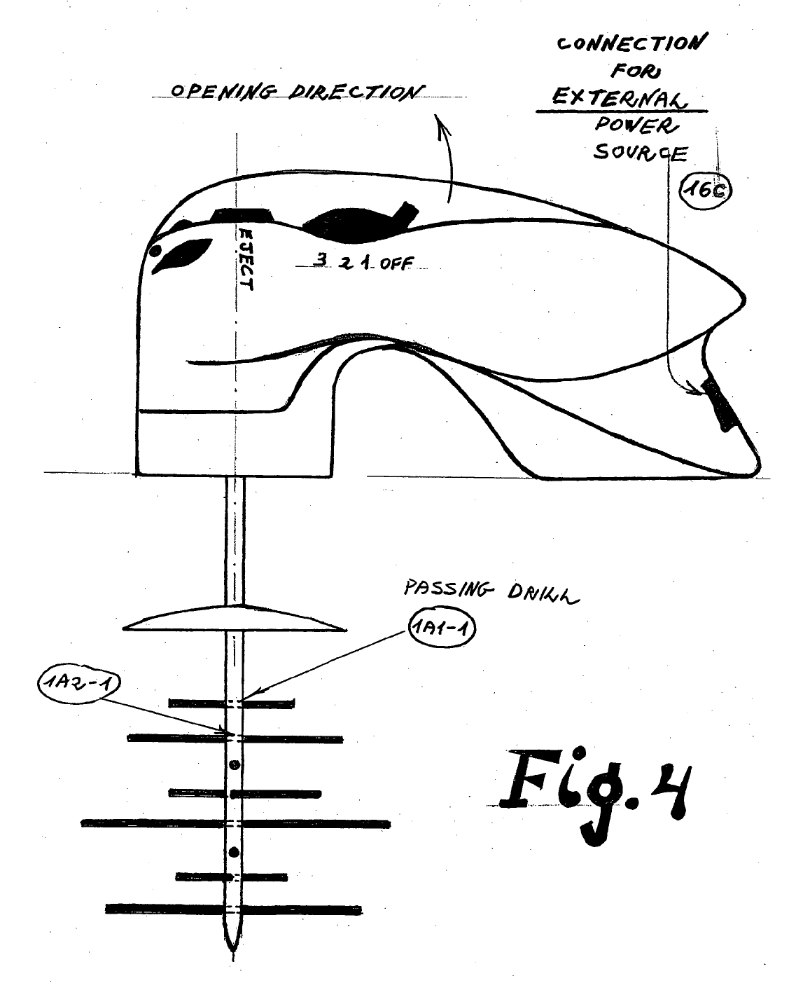

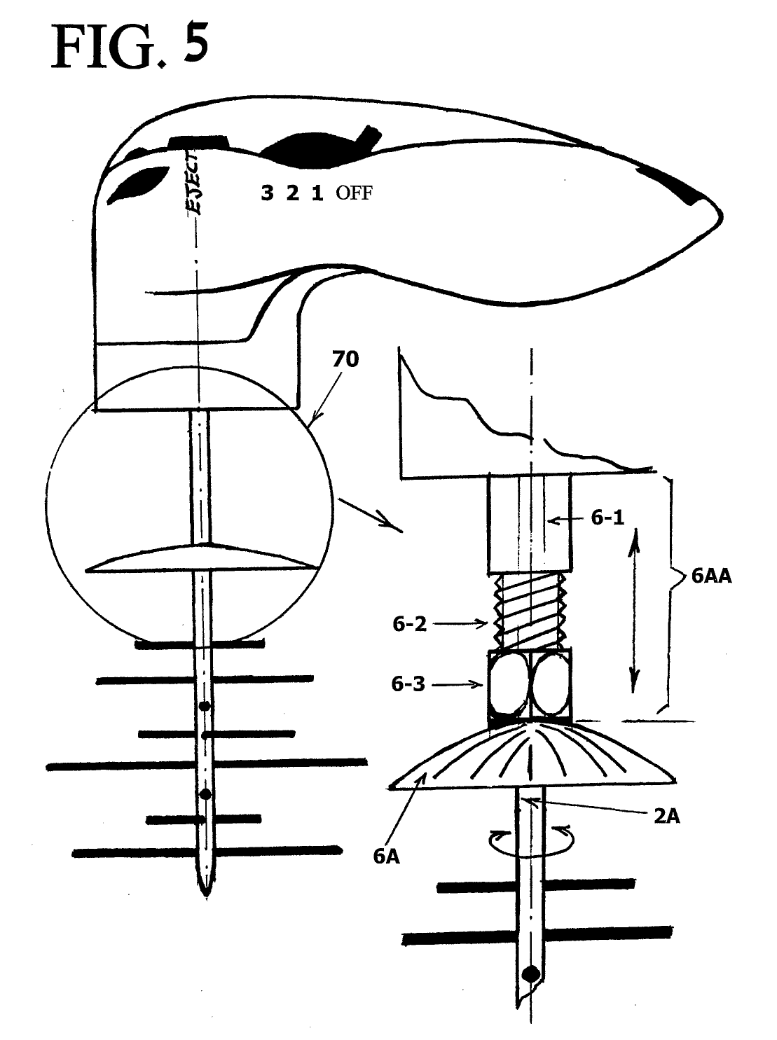

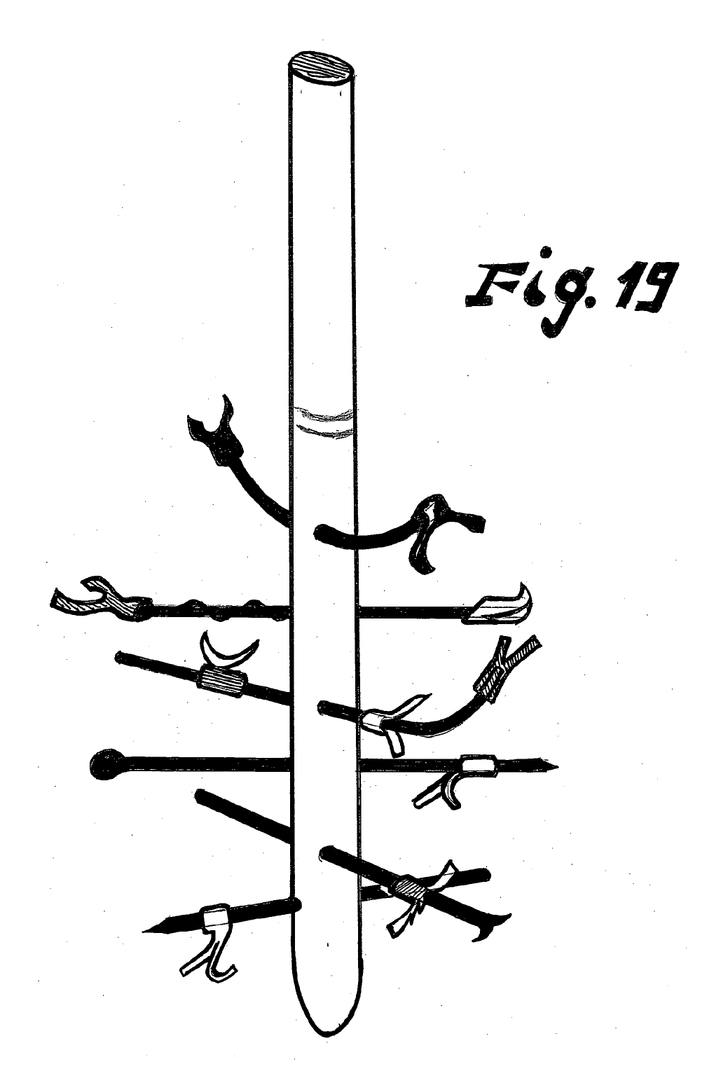

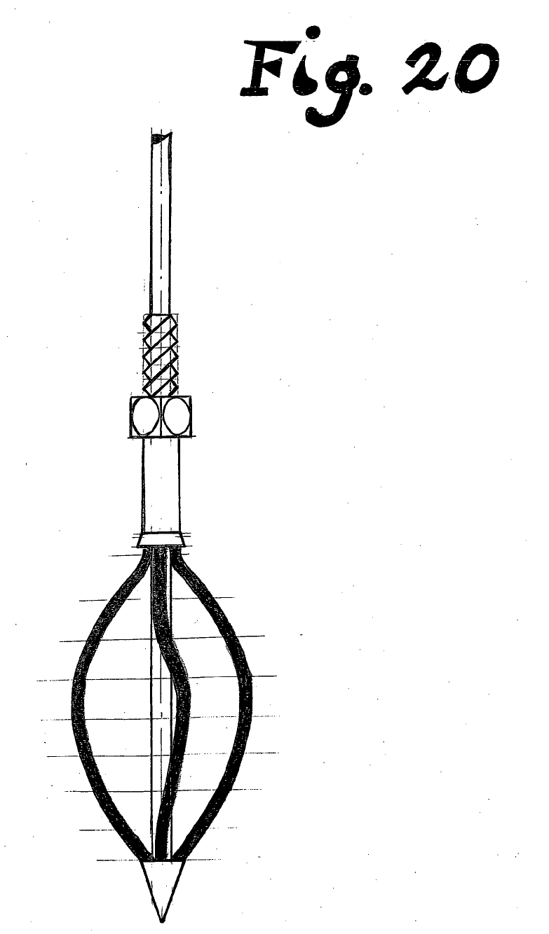

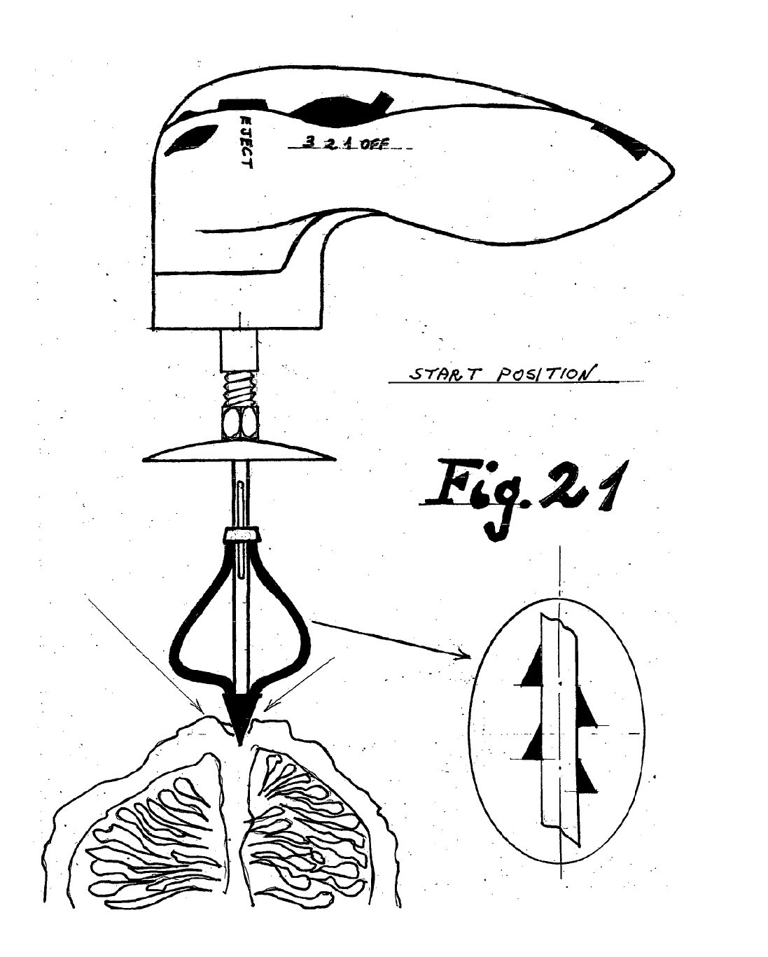

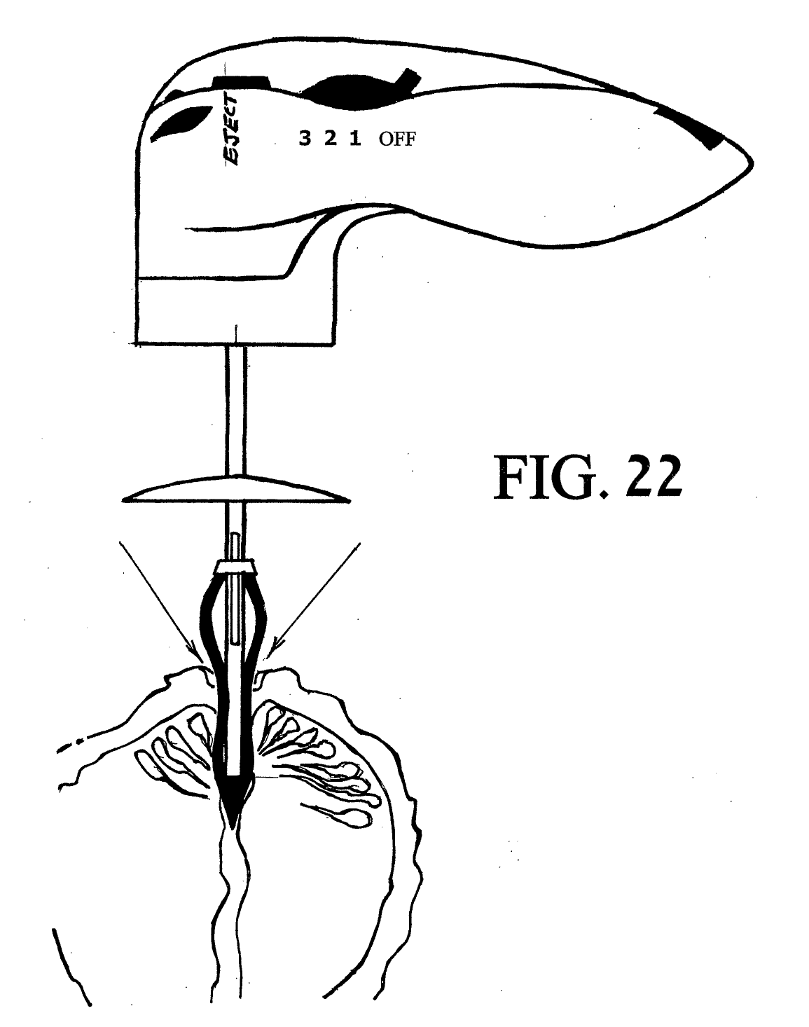

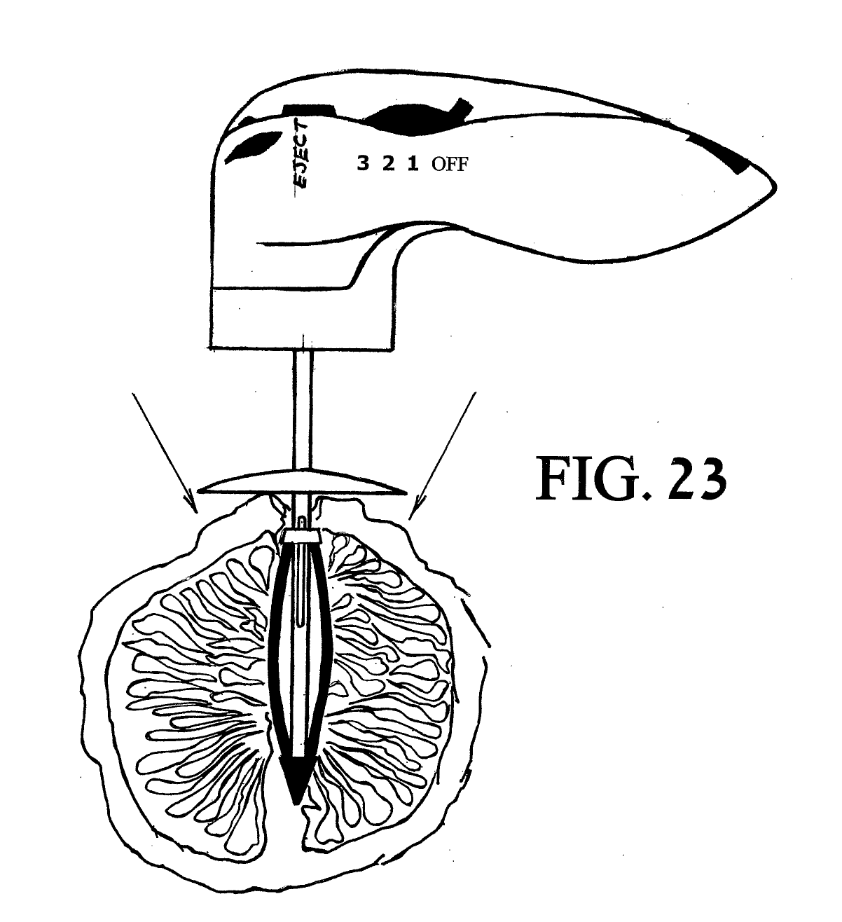

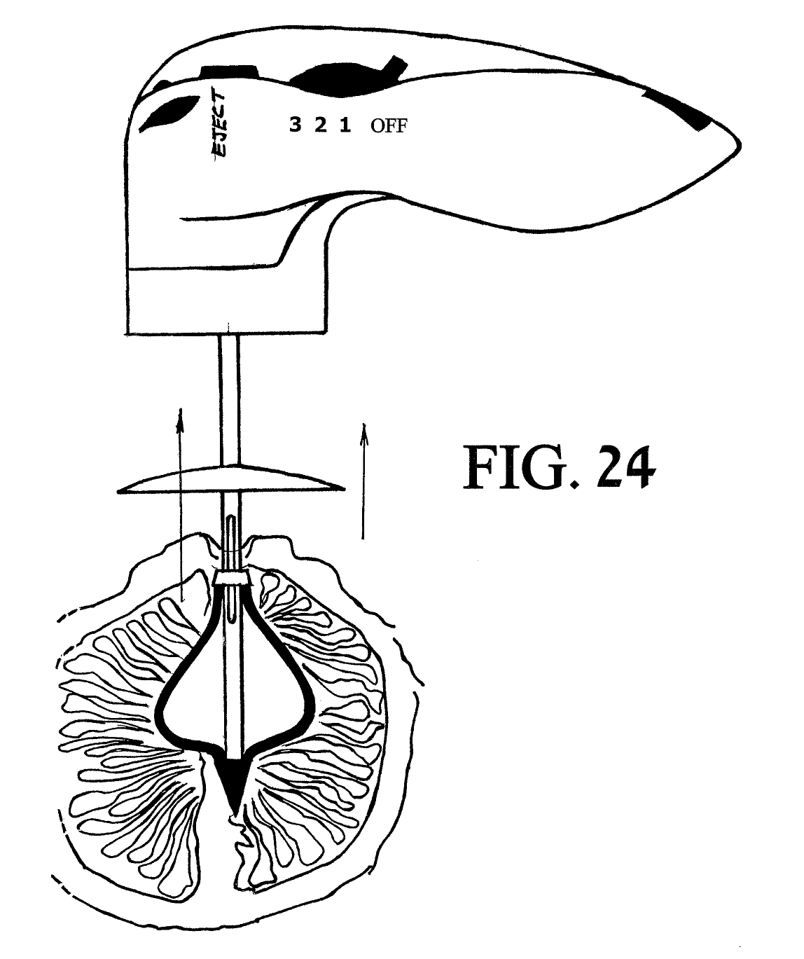

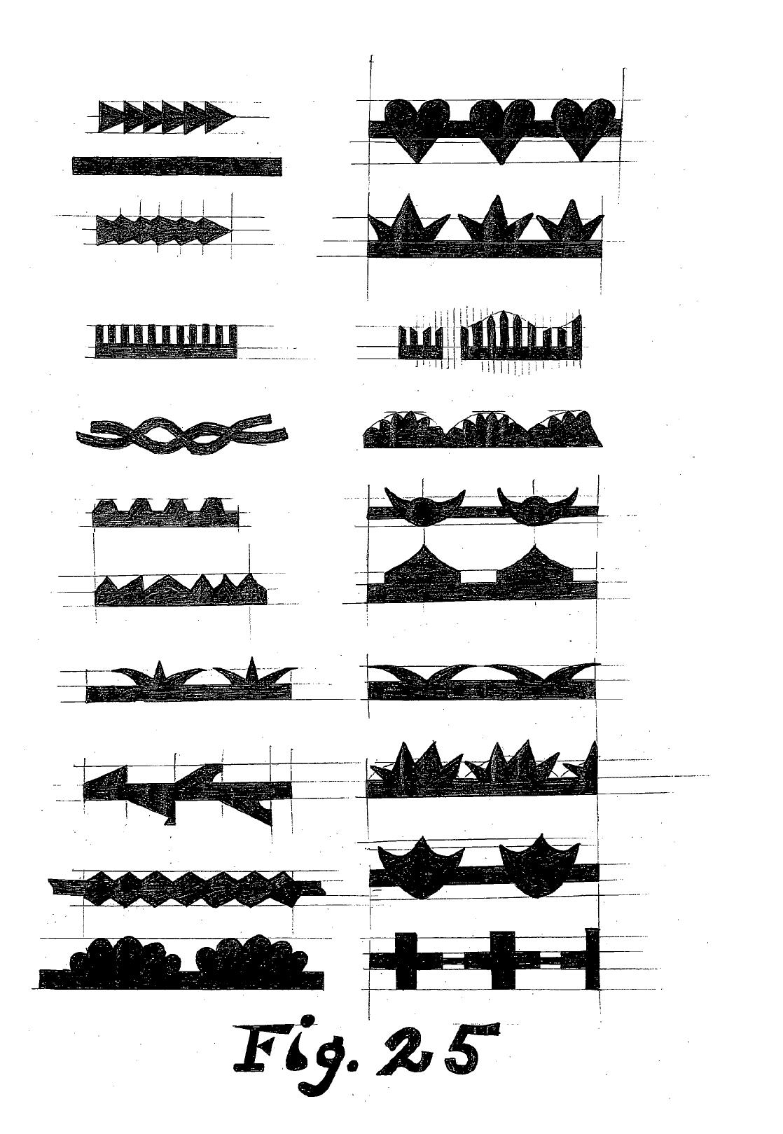

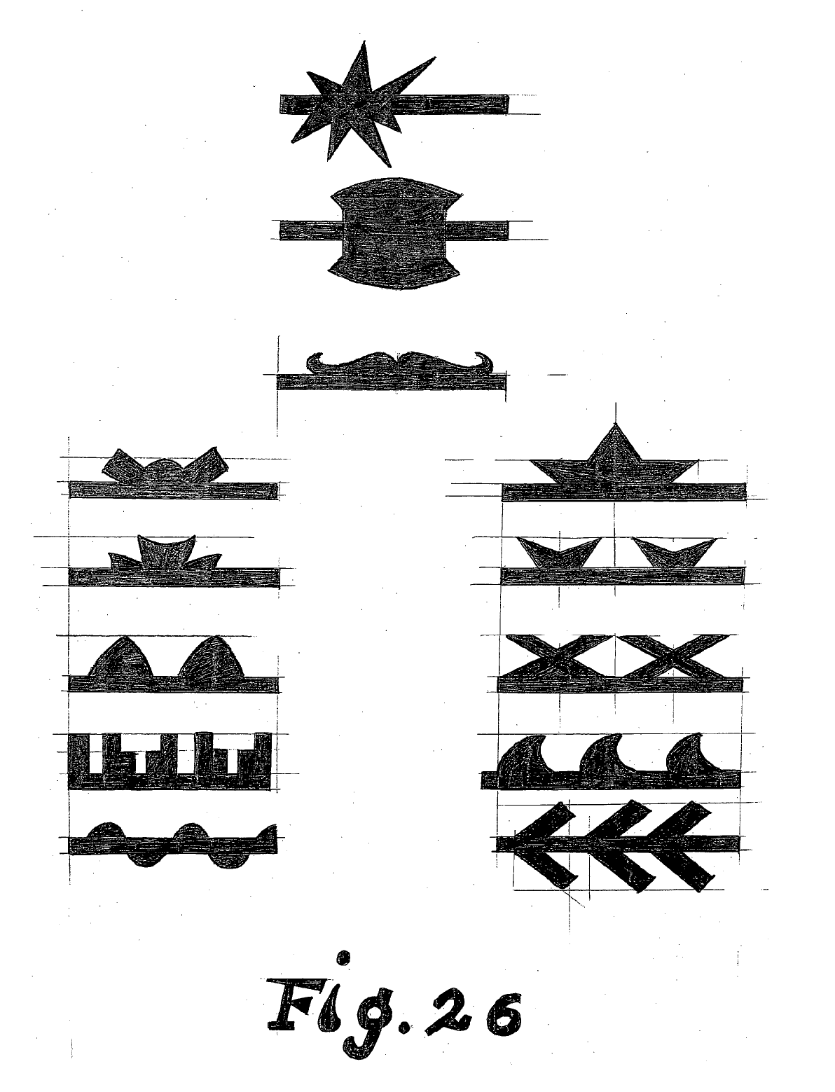

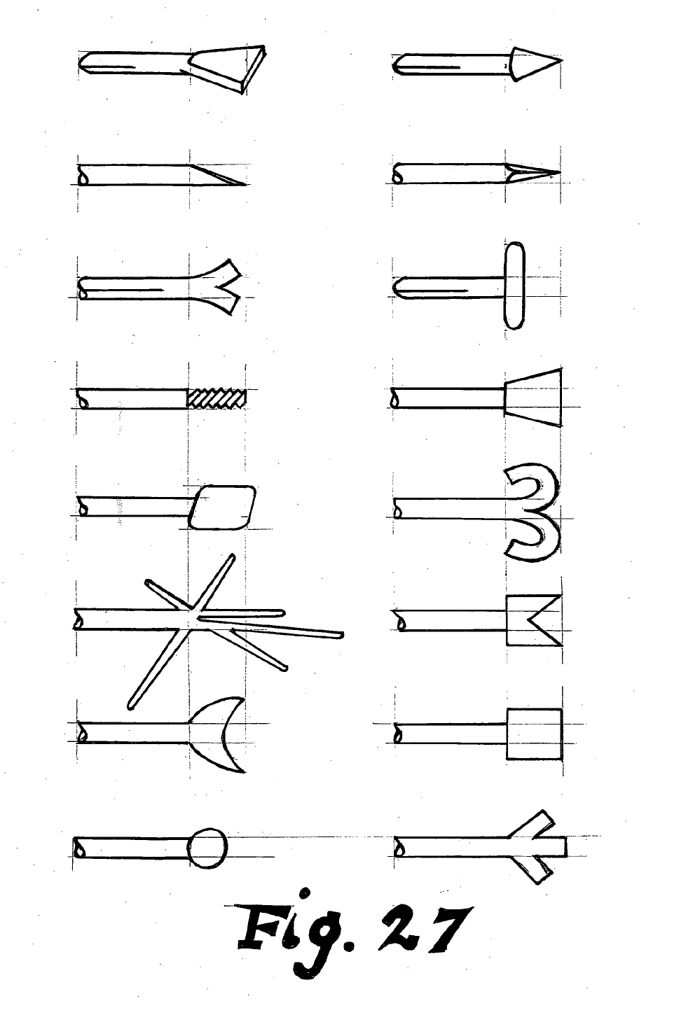

The Fruit Juicer includes the following at least four main units: (1) The Rotary Juicing Device Unit (RJD) (FIGS. 2, 14A & 13A, 14A); (2) The Control & Drive Unit (CDU) (FIGS. 2, 20A & 13A, 20A); (3) The Mechanical Interface Unit (MIU) (FIGS. 2, 4A & 13A, 4A); (4) And the Filter Straw Unit (S/M FS)—single or multi filter straw (S/M FS) (FIGS. 14, 30, & 15, 31).

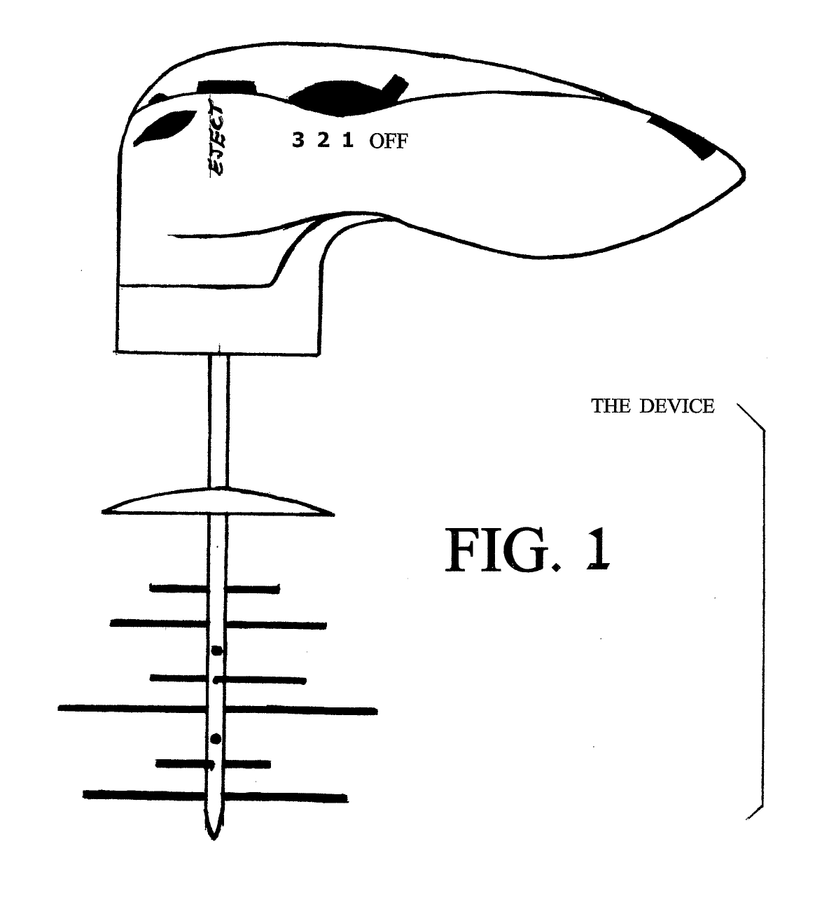

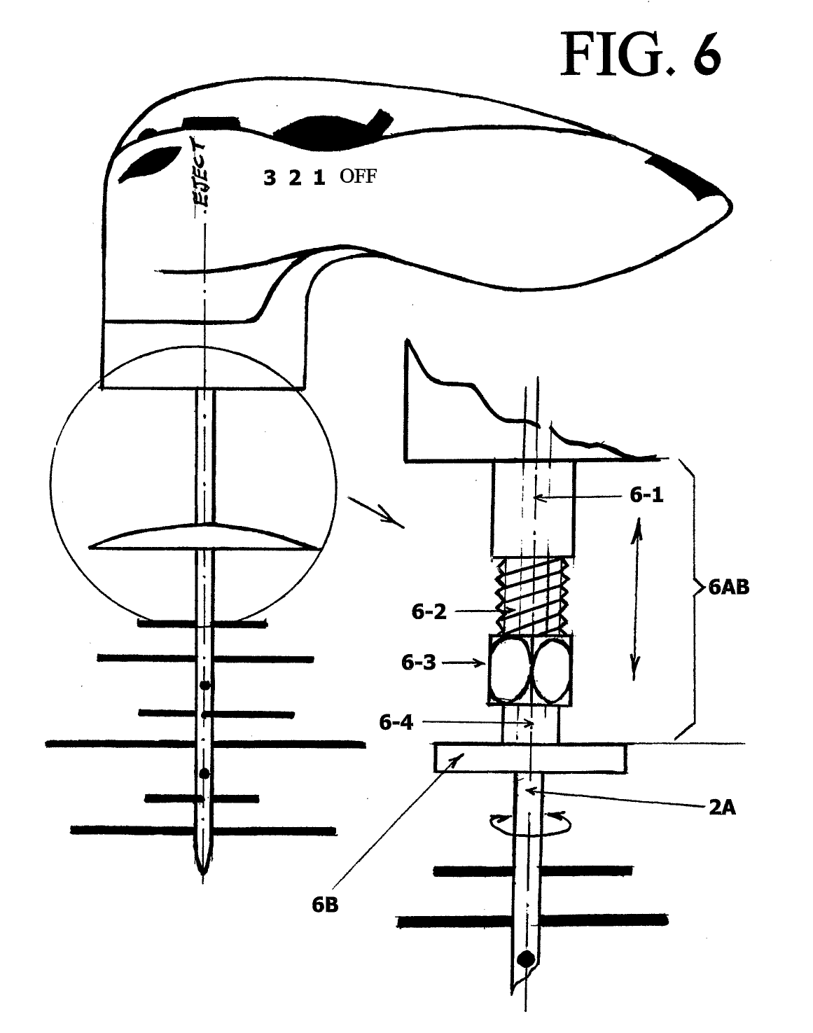

These at least four main units includes the following at least seven sub-units:
(1) The rotary juicing device unit includes at least the Mixing Rod (FIGS. 2, 2A & 2A, 2A) the Limiter (FIGS. 2, 6A & 3, 6A & 13A, 6A & 5, 6A, 6AA & 6, 6B, 6AB) and the Multi Juicing Member (FIGS. 2, 1A & 2A, 1A & 13A, 1A) sub-units.
(2) The control & drive unit includes at least the Control (FIG. 13A, 8A) and the Motor (FIG. 13A, 7) and the I/O components (FIG. 13A, 41) and the Power Supply (PS) (FIG. 13A, 9A) sub-units.

At least two physically separated main units are quickly connected or taken apart via/by the third unit which is the mechanical interface unit, to enable the juicing process: (1) The rotary juicing device unit. (2) The control & drive unit.

The Control & Drive Unit (CDU) (FIG. 13A, 20A) and the Mechanical Interface Unit (WU) (FIG. 13A, 4A) are connected and fixed physically and permanently together as one piece (FIG. 13A).

The fruit juicer may also comprise of other electronic peripheral parts like at least the control selector (switch with at least four positions) (FIG. 2, 11), the eject button plus its sensor (FIG. 13A, 12), several LED's (Light Emitting Diodes) (FIGS. 2, 13 & 2A, 22) and other User Interface components. Optionally, the fruit juicer also has the capability to upgrade the control unit to an advance control unit that has the capabilities to communicate with a host computer for processing, acceleration, deceleration, upgrading work-plans for the motor in IC's or for off line programming.

This model (only for example) of the fruit juicer is preferably cover in its upper part with a preferable transparent plastic cover (FIG. 2, 17), or from any other color, and made from any wanted material.

### The Rotary Juicing Device (RJD)

FIG. 13 shows the block diagram of the rotary juicing device according to the present invention (the source version).

FIG. 13A shows the preferable components (6A, 1A, 2A) of this unit/block (14A).

The rotary juicing device (FIG. 2, 14A) is the main unit in the present invention that is making the fruit juice in an interior of a suitable fruit (FIG. 16, 57, 68). It executes the juicing/extracting/squeezing and mixing operations mainly on the inner contents of citrus fruits mainly, in order to generate the fruits juices, under their sealed fruit peels, without any leakages.

The rotary juicing device coupled to the motor (FIG. 13A, 7) by the mechanical interface unit (FIG. 13A, 4A) and configured for retrievable introduction into the interior of the suitable fruit, the rotary juicing device being rotated by operation of the motor to produce juice that remains in the interior of the fruit, and the rotary juicing device being retrieved out of the interior of the fruit to allow introduction therein of a straw (FIGS. 14, 30 & 15, 31) for retrieving juice out of the fruit.

The rotary juicing device includes a mixing rod (FIGS. 2, 2A & 2A & 2B) supporting at least one juicing member (FIG. 2, 1C, 1E).

The mixing rod (FIG. 13A, 2A) and the at least one juicing member are configured for retrievable insertion into the interior of the suitable fruit (FIG. 16, 57, 68).

The mixing rod is a rotating straight slender stick (rod) that preferably made of non-toxic stiff and plastic rod from any color, or from a rust-proof metal rod or from a stainless steel rod, or from a wooden rod (at least like the chopsticks wood or any similar wood). It can also be made of any other material(s) that approved/certified/confirmed by the qualified authorities.

The mixing rod width shape is preferably circular or triangle or rectangular or square or any other existing shape (FIG. 2B, 46).

The at least one juicing member is flexible and pliable.

The definition—One juicing member, in this present invention relates to/defines: (1) One of the elements (FIG. 2, 1C or 1E) of a set or class (FIGS. 2, 1A & 2A &2B); or (2) one that belongs to a group; or (3) one of the individuals composing a group; or (4) a part of a whole; or (5) a unit of structure in a plant body.

To be more accurate, The rotary juicing device is an elongated assembly that has at least one juicing member that preferably made of flexible nylon line(s)/cord(s), or from flexible rust-proof metal wire(s) or from stainless spring(s) steel or from any other material that have equal or better qualities that approved/certified/confirmed by the qualified authorities. It's replacing a conventional blade.

The rotary juicing device includes also a limiter (FIGS. 2, 6A & 5, 6A, 6AA & 6, 6B, 6AB).

The limiter sub-unit is preferably a variable mechanism, that preferably biased on a screw-thread, which set manually by the user to the right value, for avoiding any damage to the suitable fruit peels, so it eliminates any juice leakage(s). Any other existing solutions from any kind for this purpose like electronic or optical sensors can also be counted.

The limiter/bumper is preferably made of plastic, or at least from rust-proof metal, or from stainless steel, or from rubber, or from cardboard or from any other material that have equal or better qualities that approved/certified/confirmed by the qualified authorities.

The limiter is preferably a fixed sub-unit that connected constantly to the mechanical interface unit (FIG. 13A, 4A & 5, 6AA, 6A & 6, 6AB, 6B) by mechanical connection, by screw-thread for example. It preferably does not rotate. Other existed solutions also can be counted and/or used.

The rotary juicing device unit adapted for attachment to the control & drive unit (FIG. 13A, 20A) via/by the mechanical interface unit (FIG. 13A, 4A) that has also a quick-release blade ability.

The rotary juicing device assembly and its components are totally electrically insulated from the control & drive unit (CDU).

The definition of—juicing members, in this present invention relates to/defines: (1) At least two of the parts (for example—FIG. 2, 1C and 1E) that make up a whole (FIGS. 2, 1A & 2A &2B). At least two of the parts can be fixed in different locations, vertical and/or horizontal angles, different elevations; or in other relevant parameters. (2) At least two of the pieces (FIG. 2, 1C and 1E) from which something is designed to be assembled (FIGS. 2, 1A & 2A & 2B).

The juicing members in the multi juicing member sub-unit (FIG. 2, 1A) perform juicing, extracting, mixing, squeezing, cutting, crushing and compress when the mixing rod (FIG. 2, 2A) rotate preferably fast in the interior of the suitable fruit.

To juice/extract/squeeze juice with the fruit juicer, the user preferably remove the fruit protuberance (FIG. 16, 38) and reveal the protuberance hole. The user enters slowly the multi juicing member (FIG. 2, 1A), from the tip (FIG. 2, 18A) into the suitable fruit, through the fruit protuberance hole, almost till the limiter adjusted height (FIG. 2, 6A). During the insertion, the juicing members folding outwardly until it enters with all of their size into the interior of the fruit. Inside the fruit, the juicing members (FIGS. 2A & 2B) bent and/or twisted randomly to all the sides during the vertical/horizontal controlled rotation of the mixing rod (FIG. 2, 2A) that connected to the motor (FIG. 13A, 7) that is fixed in the control & drive unit (FIG. 13A, 20A), so they generate juice. Any other penetration points on the fruit casing are possible but are not preferred/recommended.

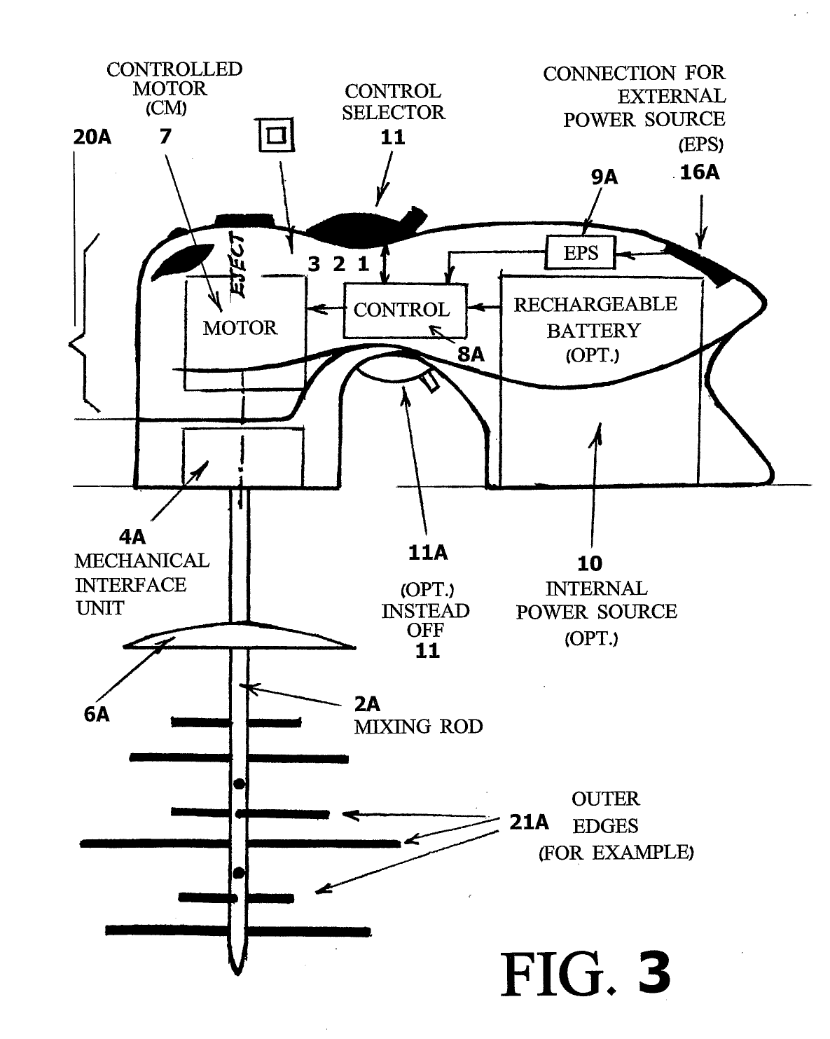

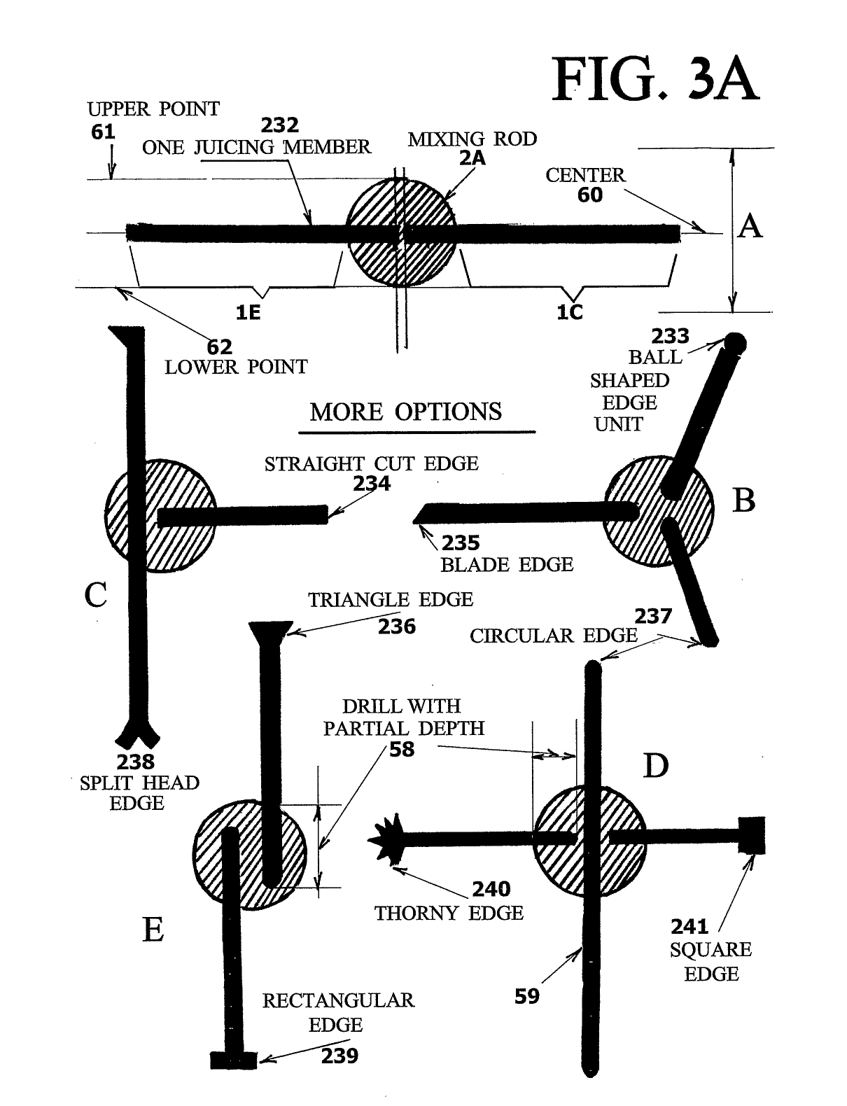

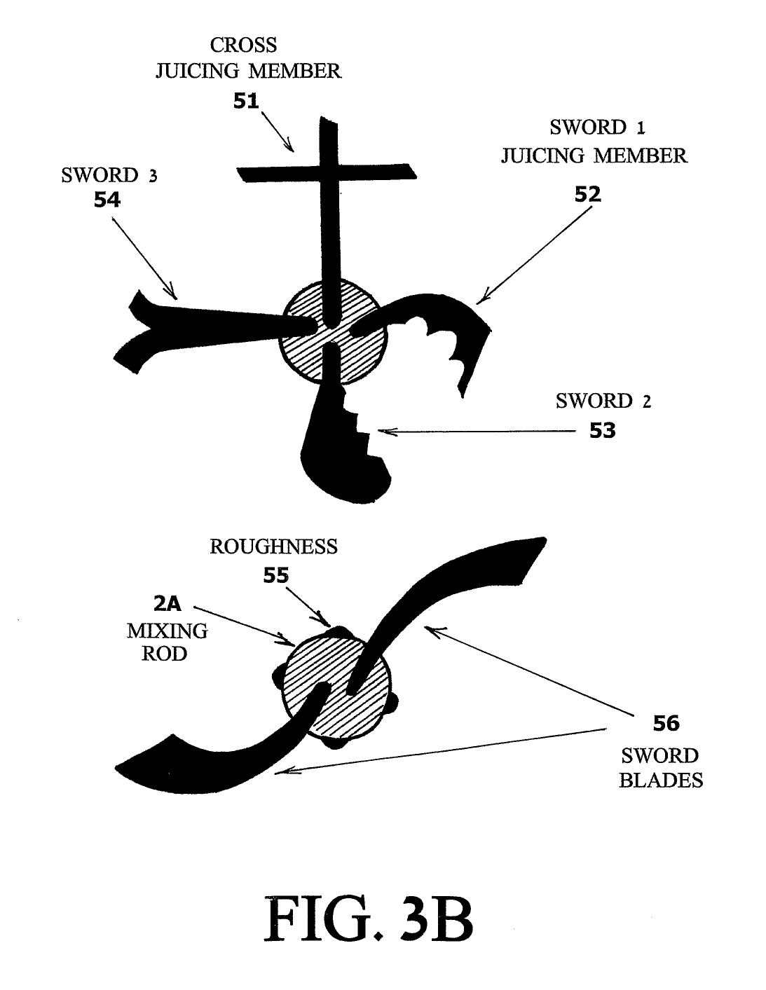

The juicing members are fixed at different elevations on the mixing rod with respect to each other (FIGS. 2, 1A & 2A & 2B). In principle, there are at least several layers of juicing members (FIG. 2A, 1A1, 1A2, 1A3 till 1A8); their quantity/number depend on the size and the structure of the suitable fruit. In every layer there is preferably at least one juicing member (FIG. 2, 1C or 1E) or several juicing members (FIG. 3A, A, B, C, D, E). Basically, there is at least one juicing member from each side of the mixing rod in the same elevation (FIG. 2, 1C, 1E). Practically, these two juicing members in the same elevation can be counted as one with two ends, if they are made from one piece that passes through a hole that was made (drilled or fro cast for example) especially for this purpose (FIG. 4, 1A1-1, 1A2-1, etc) in the mixing rod.

Each juicing member (“branch”) (FIG. 2, 1C or 1E, for example) is connected strongly to the mixing rod by the following preferred procedure:
(a) If the juicing member is made of short flexible nylon line/cord (FIG. 3A, A, B, C, D, E) with homogeneous diameter/cross section, so: (1) A hole that was drilled with a partial depth (FIG. 3A, 58) without splinters is made in the mixing rod, preferably in its center (FIG. 3A, 60). (2) The diameter of the hole is equal or a bit less then the diameter/cross section of the nylon line/cord. (3) The line/cord is pressed by force to enter the hole till its end. In case that it doesn't help, the hole is forced to become a bit wider, till the line/cord fits to the hole. (4) Option, to make the connection much stronger, suitable glue is used. If the juicing member is made of short flexible rust-proof metal wire or from short stainless spring steel (FIG. 3A, A, B, C, D, E) with homogeneous diameter/cross section, the same above-mentioned procedure is done, but instead of using the glue, fine welding is used to strength the connection between the juicing member and the metal mixing rod.
(b) If the juicing member is made of one long flexible nylon line/cord (FIG. 3A, 59) with homogeneous diameter/cross section, so: (1) A passing hole (FIG. 4, 1A1-1, 1A2-1 & 3A, 59) without splinters is made in the mixing rod, preferably in its center (FIG. 3A, 60). (2) The diameter of the hole is equal or a bit less then the diameter/cross section of the nylon line/cord. (3) The line/cord is pressed by force to pass the passing hole, to the other side. In case that it doesn't help, the hole is forced to become a bit wider, till the line/cord fits to the hole. (4) Option, to make the connection much stronger, suitable glue is used. If the juicing member is made of one long flexible rust-proof metal wire or from one long stainless spring steel (FIG. 3A, A, B, C, D, E) with homogeneous diameter/cross section, the same above-mentioned procedure is done, but instead of using the glue, fine welding is used to strength the connection between the juicing member and the metal mixing rod.

It is recommended to manufacture the mixing rod and the multi juicing member sub-units together as one piece, in one accurate casting.

Each juicing member (FIG. 2, 1C and/or 1E) in every layer (FIG. 2A, 1A1, 1A2 etc) can be built/made equally or differently from the other juicing members (FIGS. 2B & 3A & 3B) in the multi juicing member sub-unit (“tree”) (FIG. 2, 1A) according to each specific design. In principle, every juicing member got its own unique characteristics (FIGS. 2A & 2B & 3A & 3B):
(1) Thickness Shape or Width Shape of homogeneous line/cord—circle, square, oval, rectangle, star, crescent, triangle, diamond/lozenge etc (FIG. 2B, 46);
(2) Length Shape—preferably spiral (FIG. 2B, 45), or saw teethes (FIG. 2B, 49), or antenna (FIG. 2B, 48), or rotor wings (FIG. 2B, 44), or any existing shape that can be effective in the juicing/squeezing/mixing processes, that can be entered into the interior of the suitable fruit without to create any damage or defect or to ruined the entrance/exit hole;
(3) Thickness of homogeneous circle juicing member—can be 1.0 mm or 1.3 mm or 1.6 mm or 2.0 mm for example, or any other effective value that will be used, according the specific wanted application(s);
(4) Direction for winding;
(5) Active length—measured from the mixing rod to the edge of the juicing member (FIG. 2, 1C or 1E). Counted in centimeter or any other unit;
(6) Type of material—that the juicing member made of, such as flexible nylon line/cord, or from flexible rust-proof metal wire or from stainless spring steel or from any other material that have equal or better qualities that approved/certified/confirmed by the qualified authorities;
(7) Weight—the juicing member weigh;
(8) Elasticity level—the capability of a strained juicing member to recover its size and shape after deformation;
(9) Roughness level (FIGS. 2B, 39, 50 & 3B, 55);
(10) Material density level;
(11) Structure—the arrangement of the fibers or wires in the juicing member. Twined from several fibers or wires (FIG. 2B, 42) or from one homogeneous fiber or wire (FIG. 2B, 43);
(12) For heavy or light duty;
(13) Color;
(14) End piece—This is the preferable name for a component that attached on the edge of the juicing member (for example: FIG. 2B, 40 and/or 2B, 66). These components can be from different types, shapes, materials, weights, colors, and other parameters. Additionally, other names like juicing-hook or juicing piece can also define these components;
(15) Outer edge form—triangle, rectangular, thorny, square, circular, blade, straight cut, split head, etc (FIG. 2, 21A & 3A, B, C, D, E);
(16) Edge unit—a build in edge component, like ball-shaped (FIG. 3A, B) that is made from the same material of the juicing member;
(17) Angle—The angle between the inserted juicing member and the mixing rod (FIG. 2B, 63, 64 for example);
(18) Location—The location of the juicing member line/cord or the hole inside the mixing rod (FIG. 3A);
(19) Short or Long flexible line/cord (FIG. 3A);
(20) Capture method—between the juicing member and the mixing rod—by short/partial drilling or by passing drilling (FIG. 3A & 4, 1A1-1, 1A2-1 etc), or by casting the mixing rod and the multi juicing member sub-units together at one piece;
(21) Connection type—with glue or welding or just pressure between the juicing member and the mixing rod;
(22) Depth of the drilling.

The abovementioned characteristics, plus: (1) the type of the rotary juicing device (thin, thick, coarse, etc); (2) the shape of rotary juicing device (triangle, spherical, ellipse, etc); (3) the number of the active layers; (4) the rotation mode (CW, Variable, Programmed); (5) the rotation speed of the mixing rod; (6) the angle (FIG. 2B, 63, 64) and the depth of the penetration/work mode to/in the fruit; (7) the homogeneous motion in all the inner relevant content of the fruit; (8) the time work duration inside the fruit; (9) and some other motion control parameters. All these together determine the size (the inner fruit space that created inside the fruit, space that was full with fruit content that become a liquid fruit juice with pulp after the juicing, extracting, mixing, squeezing, cutting, crushing and compress processes) (FIG. 16, 65) and the quality of the juicing (the process to extract the juice of)/squeezing inside the fruits.

Each juicing member, can be place/fix in any practical and possible angle relatively to the mixing rod (FIGS. 2B, 63, 64 & 3A), according to the R&D and the products demands.

### The Mechanical Interface Unit (MIU)

The mechanical interface unit (MIU) coupled the rotary juicing device to the controlled motor.

This unit already exists in different versions and types of electrically fruit juicers—so, it is not counted as a part of the fruit juicer, but its use by the fruit juicer is recommended.

### The Control & Drive Unit (CDU)

This unit includes all the electronic control circuits with their I/O components and the electric motor (FIG. 13A, 7), which are mounted inside the sealed and the double insulation housing.

The control & drive unit (FIG. 13A, 20A) and the mechanical interface unit (MIU) (FIG. 13A, 4A) are connected and fixed physically and permanently together as one piece.

In order to operate the fruit juicer, the control & drive unit is divided into the following functional sub-units (FIGS. 13 & 13A):

(One) Motor.

The controlled motor providing a source of rotary motion that is rotate clockwise or counter-clockwise according to the user selection when commanded to operate. The rotary juicing device is being rotated by the operation of the motor to produce juice that remains in an/the interior of the suitable fruit. The motor can work in open-loop or closed-loop modes.

(Two) Control.

The control sub-unit received from one side the input signals from the power supply sub-unit and the I/O components sub-unit, and from the other side it sends the output signals to the controlled motor. It updates the Light Emitting Diodes status, and enables the motor to work in open-loop or closed-loop modes. There is an option to upgrade the control sub-unit to an advance control sub-unit that has the capabilities to communicate with a host computer for processing, acceleration, deceleration, upgrading different motion control parameters and work-programs for the motor by down loading them from computer networks/internet to CMOS IC's that have low current consumption, wide voltage range and low noise (PROM, E²PROM, non-volatile RAM, etc), or for OFF LINE programming.

(Three) Power Supply.

The power supply sub-unit switches between the external DC power source that come from an outer transformer that reduce the AC line voltage to a low DC voltage and the rechargeable battery option.

(Four) Rechargeable Battery (OPT.).

(Five) External Power Source (EPS).

The fruit juicer is powered by external source of electricity (FIG. 2, 16A) via transformer indoors or using cares battery power via the cigarette-lighter plug of 12 DCV in outdoors.

The preferred operational conditions are:
1) AC line power input, before the transformer: 115 up-to 240 Vac 50/60 Hz.
2) Ambient temperature: 10 up-to 40 C. degrees.

(Six) I/O Components.

The fruit juicer may also comprise of other electronic peripheral parts like at least the control selector (switch with at least four positions) (FIG. 2, 11), the eject button plus its sensor (FIG. 13A, 12), several LED's (Light Emitting Diodes) (FIGS. 2, 13 & 2A, 22), optional key-board define and activate the different functions of the fruit juicer and other User Interface components.

### The Filter Straw (S/M FS)

When the juice is ready inside the suitable fruit, the rotary juicing device being retrieved out of the interior of the fruit to allow introduction therein of a straw for retrieving the juice out of the fruit, filtered or not. Actually, the entire fruit peel apricot as a drinking cup.

A straw is a long tube, made of paper, plastic, glass or any other delegated material, for sucking up a beverage.

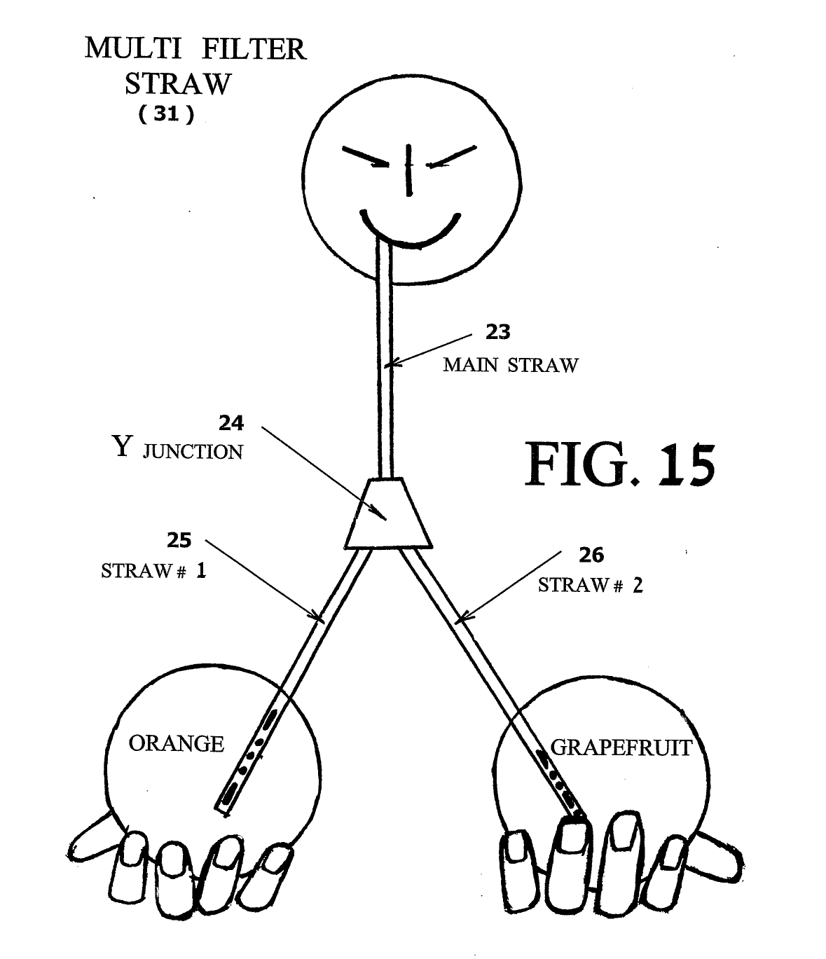

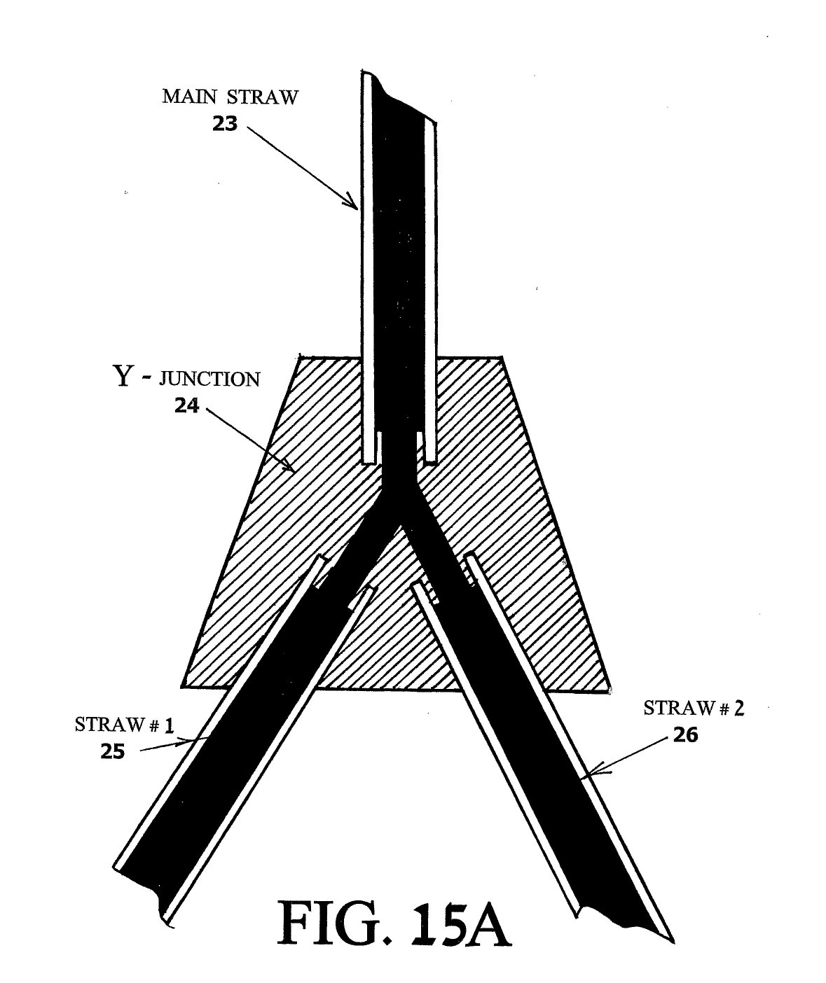

There are three preferable straws in the present invention: (1) the single filter straw (FIG. 14, 30); (2) the multi filter straw (FIG. 15, 31); (3) and the inner filter straw, that is built inside the mixing rod., from its top till almost its bottom.

The single filter straw (FIG. 14, 30) is a long straight tube made of stiff colored paper, plastic, or glass, or from any other delegated material, open in its upper end and close or open in its lower end, with many holes at least from one side, but preferably from all the sides, from different diameters has described in FIG. 14. By that the filter effect achieved.

The multi filter straw (FIG. 15, 31) includes the following at least three main units: (1) The main straw (FIG. 15, 23); (2) The Y-Junction (FIG. 15, 24); (3) The at least two straws—Straw # 1 (FIG. 15, 25), and Straw # 2 (FIG. 15, 26). The main straw is preferably made from stiff and thin colored plastic tube, opened from its two ends, without any holes in its sides. It is connected in its lower end to the Y-Junction (FIG. 15A, 23). The Y-Junction in the present invention is preferably a plastic device/an interface at which in one point several straws/tubes from several fruits are connected, to allow easy flow of juice out from the fruits, through the main straw. The preferred solution is described in FIG. 15A, 23. It joins at least three straws. Any other existing and suitable Y-Junctions can also be counted. Straw # 1 and Straw # 2 are two single filter straws, as described above (FIG. 15A, 25, 26).

The inner filter straw, is built/drilled/shaped or cast inside the mixing rod, from its top till almost its bottom. In this case the mixing rod becomes exactly like the single filter straw that constructed outside as the rotary juicing device, and from its inner side, its as a passing hole not exactly till its end, to enable the juice flow, to go out. In order to use this inner filter straw, the user need to finish the extracting process, then the user instantly can use the straw. This inner straw can be made also from two parts: (1) the single filter straw inside the mixing rod; (2) plus another inner straw inside the single filter straw, with sealed walls, that during the extracting process is inside the single filter straw. When the extracting process finished, the user pull it up, and drink the desired juice.

### The Cork & the Suitable Base

FIG. 16 Shows the side/front & cross-section view of an interior of a suitable unfinished fruit with a cork, plus a cork & straw interface, plus a suitable base for the fruit, for complementary usage with the present invention (for all the versions), for industrial fruits lines, or for personal usage. An unfinished fruit is a fruit that still contains some liquid juice in its interior. To store unfinished juice inside the fruits, in indoors appliances such as refrigerators, or in outdoors, a cork (FIG. 16, 27) is in use to seal the hole in the fruit peel. The cork unit already exists in different versions of products—so, it is not counted as a part of the device, but its use by the device is recommended. To eliminate any possibility that the fruit will roll, a suitable base (FIG. 16, 28, for example) is made to lay it on, so to prevent any leaks from the fruit. Any other bases are already exists in different versions of products—so, it is not counted as a part of the device, but its use by the device is recommended.

### The Cork & Straw Interface (CSI)

FIG. 16A Shows the perspective view of a cork & straw interface (CSI) that brought in/stuck preferably into the protuberance hole of a suitable fruit, for complementary usage in the present invention (for all the versions). Before entering the straw, the user puts the cork & straw interface, into the protuberance hole and through its hole he pass the straw inside into the interior of the fruit. This is a part of the invention, and preferably made from a plastic ring with a big hole in its middle and several plastic hooks under it, to enables good sealing and holding. To improve the sealing, a plastic or rubber or any other wanted material washer can be used.

### DETAILED DESCRIPTION FOR VERSION #2

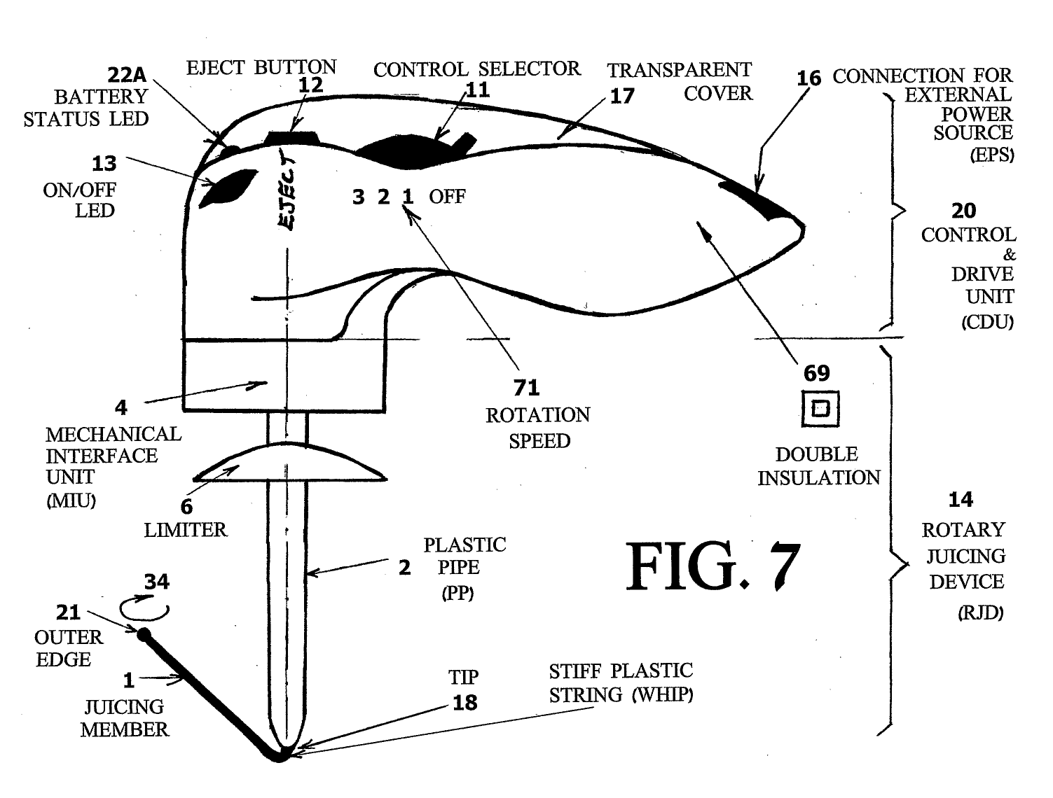

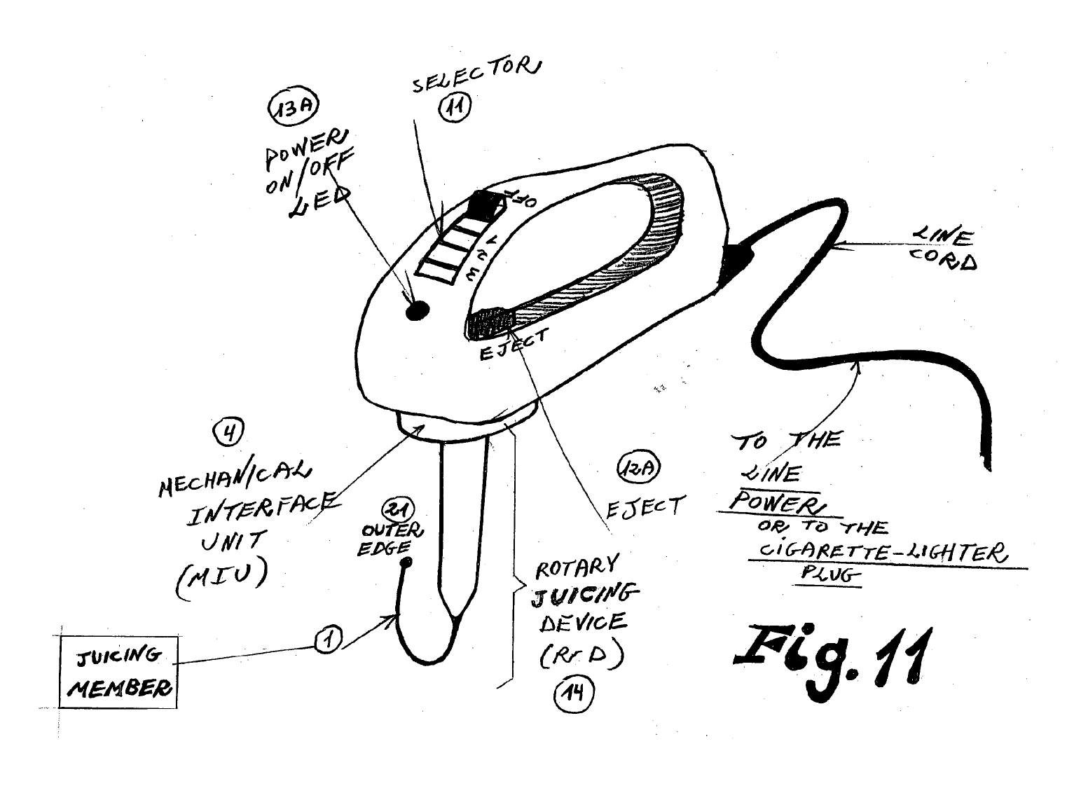

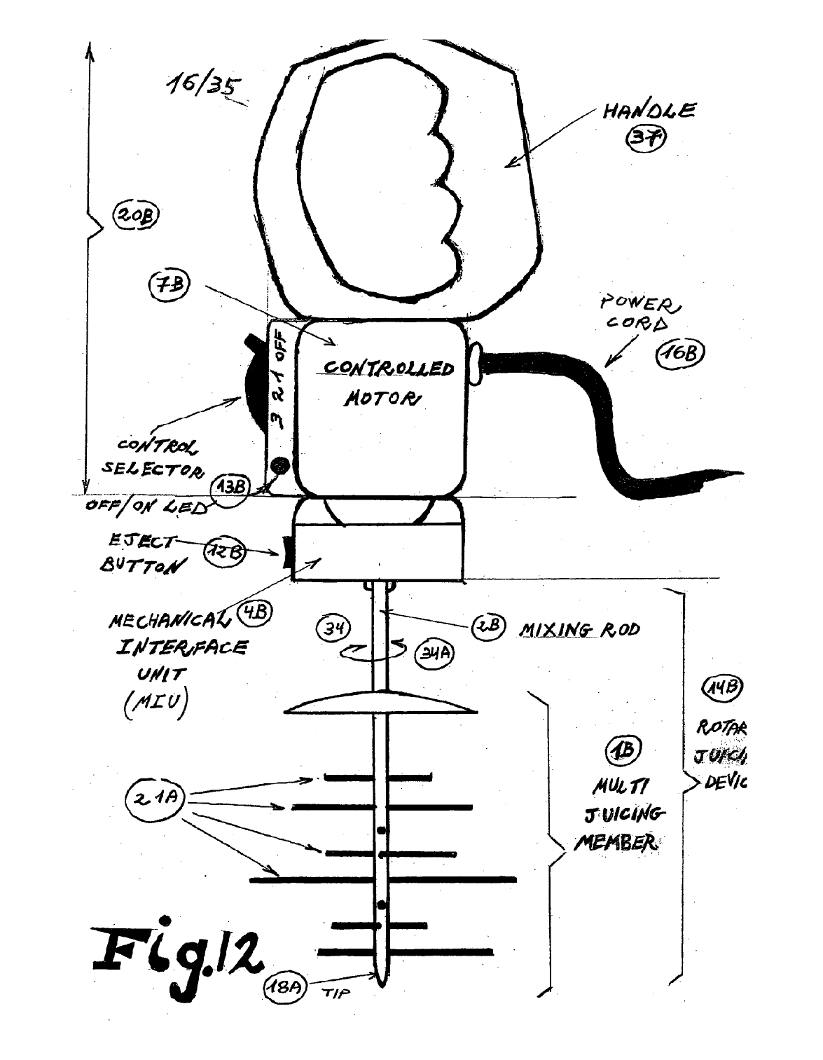

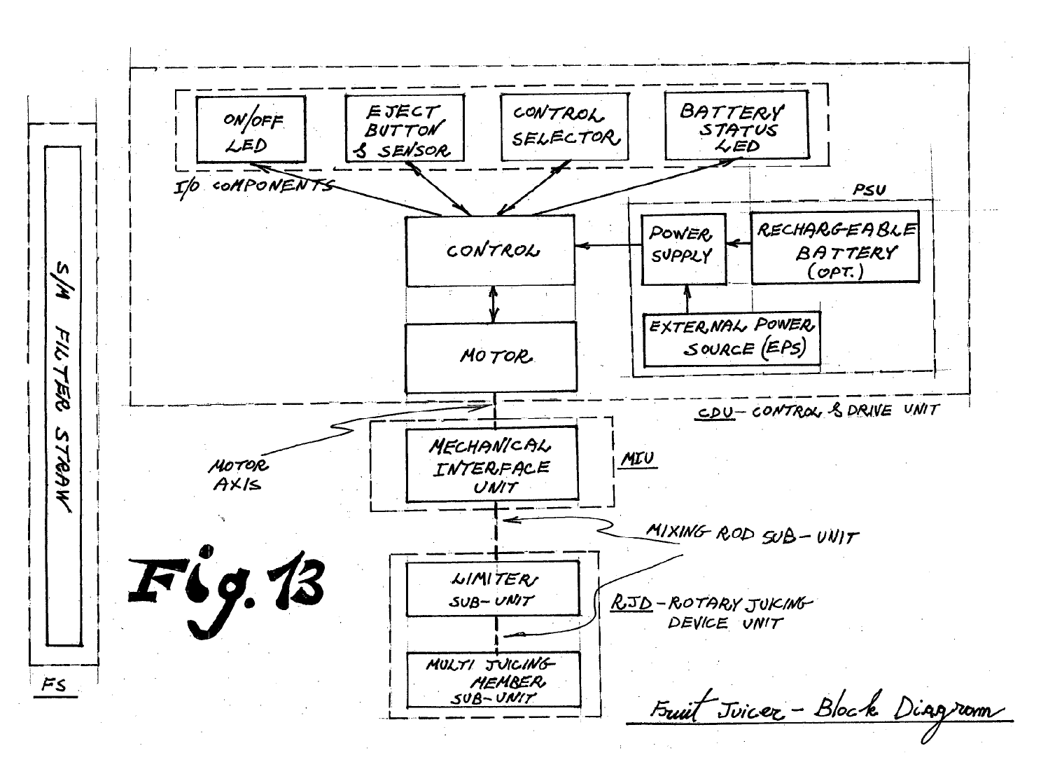

The rotary juicing device includes a means for coupling the rotatable head (RH) (FIG. 10, 29) to the juicing member (FIG. 7, 1). Preferably it's a cast connection, or any other suitable solution.

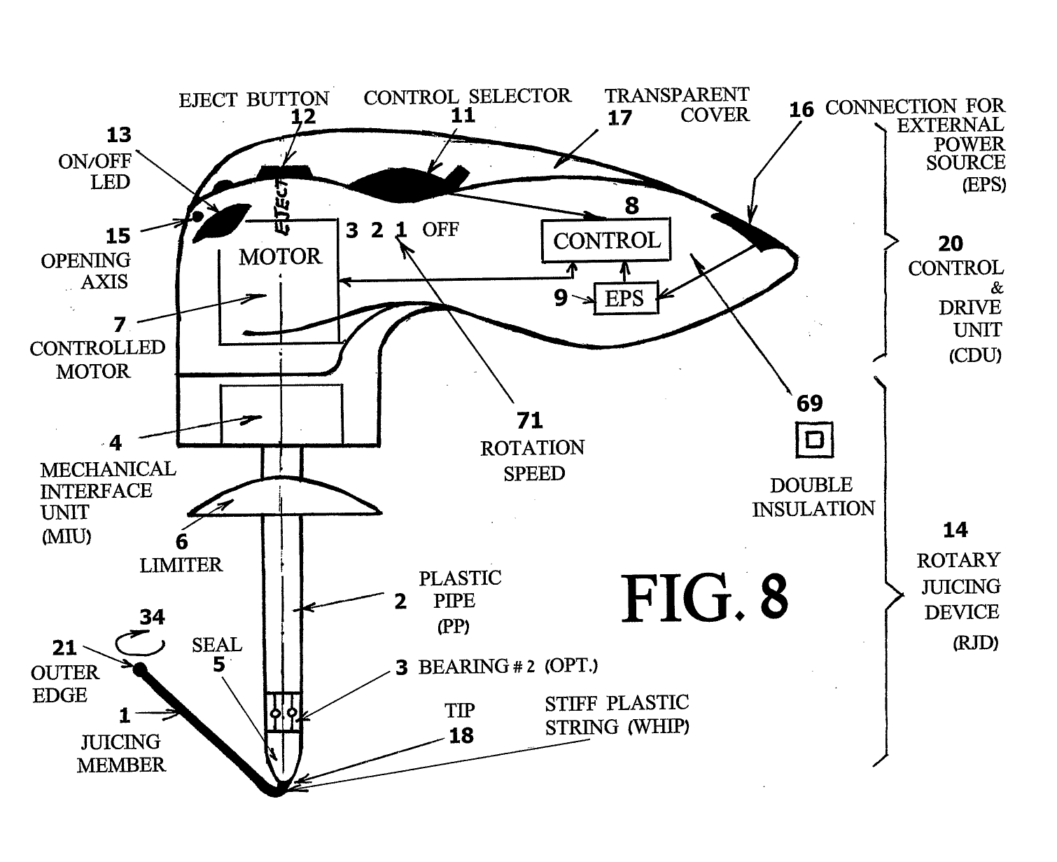

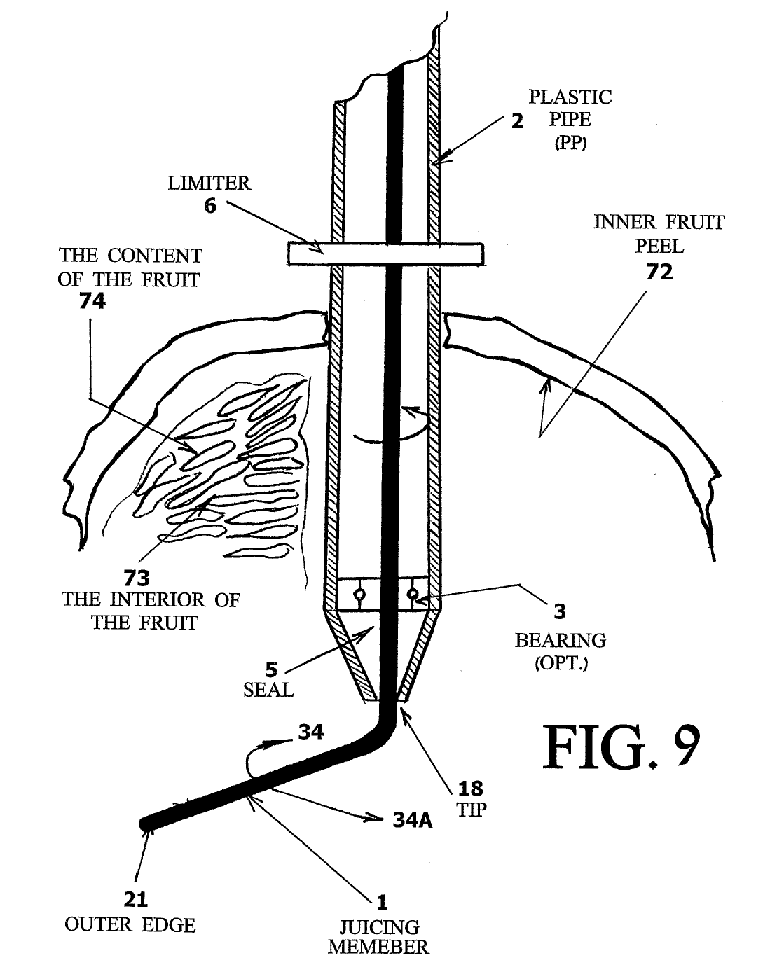

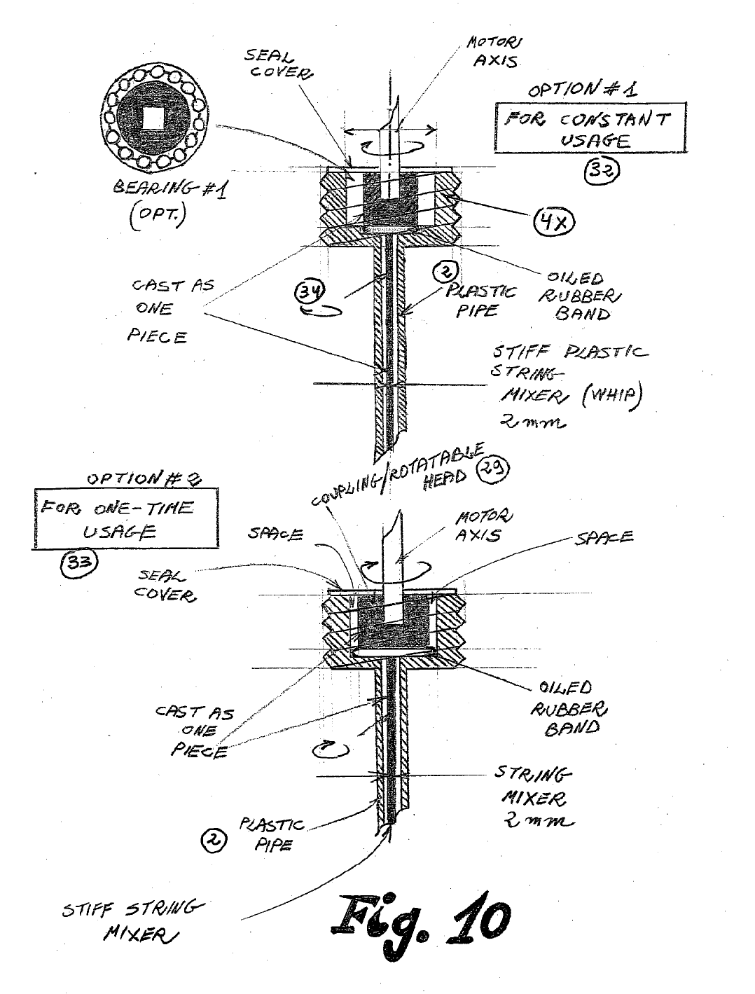

The narrow sealed rotary juicing device (FIG. 8, 14) inserted by the user into the wanted fruit vertically, through a hole that it creates within the penetration, to the depth of several centimeters, to execute the juicing, squeezing, crushing and the mixing procedures, which will produce later the desired natural fruit juice or mixture.

The rotary juicing device based on a juicing member (FIG. 7, 1) that made of a flexible and stiff nylon string surrounded and secured by a narrow elongated mounting cover made of hard and thin plastic pipe (FIG. 7, 2), adapted for attachment to the control & drive unit (FIG. 7, 20) via/by its mechanical interface unit (MIU) (FIG. 7, 4).

To avoid any damage to the inner fruit peel during the juicing/squeezing/mixing processes, a preferable plastic limiter (FIGS. 7, 6 & 9, 6) is in usage, tight-fitting on the plastic pipe of the rotary juicing device for defining, setting and locking the maximum penetration depth to the specific fruit, by the user, according to its size and the user's will.

The juicing member (FIG. 8, 1) is made preferably from nylon or other polymers. It is absolutely obvious that all these materials must to be un-toxics.

The rotary juicing device assembly and its components are totally electrically insulated from the control & drive unit (CDU).

The juicing member is using preferably a flexible nylon line/cord, or flexible rust-proof metal wire or stainless spring steel wire as a blade, instead of a conventional blade with or without an end piece. Any other suggested line/cord/wire from any other material(s) must have at least equal or better qualities that approved/certified/confirmed by the qualified authorities.

The juicing member, works as a high speed-rotating whip with a random direction movement, to most of the sides. During its movement, the “whip” bent and twists randomly to crush grind and to generate natural juice and blend/puree under the fruit peel, when the flexible nylon string is rotated by the controlled motor sub-unit.

The juicing member is attached (by cast connection, for example) in its upper end to a rotatable head (RH) (FIG. 10, 29), that connected through the mechanical interface unit (MIU) (FIG. 8, 4) with a dissolving connection to a powerful fast and small motor (FIG. 8, 7) in the control & drive unit (FIG. 7, 20).

The tip (FIG. 8, 18) of the plastic pipe (FIG. 8, 2) got at least one hole that supports at least one cutting element (FIG. 7, 1). The tip shape is cone basically, but it can be also square or in any other shape such as circular, thread etc.

The juicing member rotates around a vertical axis, that centered on a hole (FIG. 7, 18) in a clockwise (FIG. 7, 34) or counter clockwise directions. Optionally, the inner vertical axis connection, from the rotatable head till the tip, can be made from a straight stiff and thin plastic rod, that in its lower end is connected to the flexible nylon string—the juicing member.

The outer edge (FIG. 7, 21) of the juicing member is made preferably of a small ball in order to prevent any damage to the inner fruit peel while it's rotating fast inside the fruit. The juicing member is preferably made of one flexible nylon cord therefore its outer edge is made preferably from nylon. If the juicing member is made from another material such as metal wire or spring steel, therefore the outer edge will be made preferably from the same material. Other types of outer edges are useful in this invention, such as straight cut, cone cut, or any other geometric shape. Other solutions provide different cutting tools and end pieces.

According to the type of a said fruit, the user select respectively the proper type of the rotary juicing device, small or medium or large size. Mediums rotary juicing device have a medium length of plastic pipe and juicing member that fits for the orange or grapefruit, for example. A large rotary juicing device, have a large length of plastic pipe and line mixer segment that fits for the melon and watermelon, for example. These selections define the suitable solutions.

### PROCESS DESCRIPTION

The user pick and hold the specific fruit that he wants.

The user connect physically the suitable rotary juicing device (RJD) to the mechanical interface (MIU) of the fruit juicer.

The user adjusts the limiter location accordingly to the fruit type and size.

The user enters the multi juicing member sub-unit (all its size) with all its flexible juicing members and their components (end devices, edge units, etc), slowly into the interior of the said fruit vertically, preferably through the protuberance hole, without any rotation.

When done, the user operate the motor, that rotate the rotary juicing device unit.

The user grasp the fruit in one hand and with his second one he bends the mixing rod slowly and randomly inside the fruit, several seconds, to different sides directions and angles to achieve the best juicing results.

The juicing members perform juicing , extracting, mixing, squeezing, cutting & crushing that producing juice, that remains in the interior of the fruit.

The user stops the motor movement.

If the user is using a rotary juicing device with an inner filter straw inside the mixing rod, he can immediately, start to drink, from the fruit through the rod with this unique straw.

If the user is not using a rotary juicing device with an inner filter straw inside, then he retrieve out from the interior of the fruit the rotary juicing device, slowly.

The user enters the cork & straw interface (CSI) into the hole that the rotary juicing device produced before.

The user enters a regular straw through the cork & straw interface for retrieving juice out of the fruit, but it is preferable to use the straws of the present invention.

The user finish to drink the juice from the fruit.

When done, the user retrieve out the used straw.

If the user wants another fruit from the same type, to continue the process, jump to paragraph [0120].

If the user don't wants another new fruit from the same type, and don't wants another new fruit from a different type, and don't wants to clean the current straw for returning use, then he should throw the fruit plus the current straw together straight to the garbage. In such a case, this is the end of the process.

If the user wants another new fruit from a different type, he should physically retrieve out the rotary juicing device from the mechanical interface (MIU) of the fruit juicer and to clean and keep/store it. When done, to continue the process, jump to paragraph [0117].

If the user wants to clean the current straw for returning use, then he should clean and store it. In such a case, this is the end of the process, also.

Note:

If a user is willing to get out-side the inner fruit juice, after or during the extraction process, all he needs to do is just to make a hole in the bottom of the fruit, using the rotary juicing device tip, and so he'll be abele to fill a glass, for example.

1. A juicer for processing a fruit or vegetable having a relatively soft marrow and relatively hard peel, said juicer comprising:
a controlled motor for providing a source of rotary motion; and
a juicing tree assembly comprising:
a main stem shaft, rotationally coupled to said motor, and
at least one juicing branch member, affixed to said stem shaft, wherein said at least one juicing branch member is characterized by a certain degree of pliability;
wherein said juicing tree assembly is insertable into said fruit or vegetable via a relatively small opening in said peel thereof, while said at least one juicing branch member is bent towards said stem shaft, and
whereby upon insertion of said juicing tree assembly into said fruit or vegetable and operation of said motor, said fruit or vegetable is processed essentially within said peel thereof, by rotating said juicing tree assembly therein.

2. The fruit juicer according to claim 1, wherein:
said at least one juicing branch member further comprises a plurality of cutting elements.

3. The fruit juicer according to claim 2, wherein:
said at least one juicing branch member comprises a nylon-like string having a plurality of cutting elements threaded thereon.

4. The fruit juicer according to claim 2, wherein:
said at least one juicing branch member comprises a closed-loop.

5. The fruit juicer according to claim 4, wherein:
said at least one juicing branch member comprises at least one plummet.

6. The fruit juicer according to claim 1, wherein:
said juicer is a portable handheld appliance.

7. The fruit juicer according to claim 1, wherein:
said juicer is a stationary appliance comprising:
a pedestal;
a post, and
a descending mechanism,
a fruit mount.

8. The fruit juicer according to claim 1, wherein:
said main stem shaft comprising a straw.

9. The fruit juicer according to claim 1, wherein:
said juicer comprises a limiter.

10. A method of processing a fruit or vegetable having a relatively soft marrow and relatively hard peel so as to prepare a fresh juice within the interior thereof, said method comprising the steps of:
providing a juicing tree assembly which comprises:
a main stem shaft, rotationally coupled to said motor, and
at least one juicing branch member, affixed to said stem shaft, wherein said at least one juicing branch member is characterized by a certain degree of pliability;
inserting said juicing tree assembly into the interior of said fruit or vegetable, and
coupling said juicing tree assembly to a source of rotary motion;
whereby said juice is prepared within the interior of said fruit or vegetable.

11. The method of processing a fruit or vegetable to prepare a fresh juice within the interior thereof as in claim 10, wherein:
maximally applicable values of rotational speed for said juicing tree assembly are about 300 RPM.

12. The method of processing a fruit or vegetable to prepare a fresh juice within the interior thereof as in claim 10,
characterized by formation of a drain aperture in said peel of said fruit or vegetable.

13. The method of processing a fruit or vegetable to prepare a fresh juice within the interior thereof as in claim 10, further comprising the steps of:
accelerating the rotational speed of said juicing tree assembly's main stem shaft from zero to about 300 RPM;
remaining the rotational speed of said juicing tree assembly's main stem shaft at about 300 RPM for about 60 seconds;
abruptly decelerating the rotational speed of said juicing tree assembly's main stem shaft to zero RPM
whereby the pulp and/or other non-liquid fractions are urged toward said peel due to the centrifugal force resulting said rotational movement and a substantially clear juice is produced.

14. The method of processing a fruit or vegetable to prepare a fresh juice within the interior thereof as in claim 10, further comprising the steps of:
accelerating the rotational speed of said juicing tree assembly's main stem shaft from zero to about 300 RPM;
further accelerating the rotational speed of said juicing tree assembly's main stem shaft to about 300 RPM;
remaining the rotational speed of said juicing tree assembly's main stem shaft at about 300 RPM for about 15 seconds;
abruptly decelerating the rotational speed of said juicing tree assembly's main stem shaft to zero RPM
whereby the pulp and/or other non-liquid fractions are urged toward said peel due to the centrifugal force resulting said rotational movement and a substantially clear juice is produced without destroying the biologically pivotal ingredients thereof.

15. The method of processing a fruit or vegetable to prepare a fresh juice within the interior thereof as in claim 10, wherein rotational speed is controlled by the means of temperature measurement/s.
